(19) United States
(12) Patent Application Publication
(10) Pub. No.: US 2020/0162767 A1
(43) Pub. Date: May 21, 2020

(54) SYSTEMS AND METHODS FOR SIGNALING OF VIDEO PARAMETERS

(71) Applicant: Sharp Kabushiki Kaisha, Sakai City, Oaska (JP)

(72) Inventor: Sachin G. DESHPANDE, Camas, WA (US)

(21) Appl. No.: 16/338,705

(22) PCT Filed: Oct. 3, 2017
(86) PCT No.: PCT/JP2017/035993

§ 371 Date: Apr. 2, 2019

Related U.S. Application Data
(60) Provisional application No. 62/404,625, filed on Oct. 5, 2016.
(60) Provisional application No. 62/445,699, filed on Jan. 12, 2017.

(51) Int. Cl. H04N 21/235; H04N 21/435; H04N 19/70; H04N 21/84

(52) U.S. Cl. CPC H04N 21/2353; H04N 21/84; H04N 19/70; H04N 21/435

(57) ABSTRACT

A device may be configured to signal video parameters using a media transport protocol. The device may signal constraints associated with an encoded layer of video data. The device may signal one or more flags indicating whether a type of information associated with encoded video data is signaled. Flags may include one or more of a temporal scalability information present flag, a scalability information present flag, a multi-view information present flag, a picture quality information present flag, picture rate information present flag, a bit rate information flag and a color information present flag.

### TECHNICAL FIELD

The present disclosure relates to the field of interactive television.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks and unidirectional networks, such as digital broadcast networks.

Digital media content may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards. The ATSC 3.0 suite of standards seek to support a wide range of diverse video services through diverse delivery mechanisms. For example, the ATSC 3.0 suite of standards seeks to support broadcast video delivery, so-called broadcast streaming/file download video delivery, so-called broadband streaming/file download video delivery, and combinations thereof (i.e., “hybrid services”). An example of a hybrid video service contemplated for the ATSC 3.0 suite of standards includes a receiver device receiving an over-the-air video broadcast (e.g., through a unidirectional transport) and receiving a synchronized video presentation from an online media service provider through a packet network (i.e., through a bidirectional transport). Current proposed techniques for supporting diverse video services through diverse delivery mechanisms may be less than ideal.

### SUMMARY OF INVENTION

One embodiment of the present invention discloses a method for signaling video parameters associated a video asset included in a multimedia presentation, the method comprising: signaling color information in a descriptor associated with the video asset, wherein color information conditionally includes a flag indicating whether an electro-optical transfer function information data structure is present; and in the case where the flag indicating whether an electro-optical transfer function information data structure is present indicates an electro-optical transfer function information data structure is present: signaling a syntax element indicating a length in bytes of an electro-optical transfer function information data structure; and signaling an electro-optical transfer function information data structure corresponding to the syntax element indicating a length in bytes of an electro-optical transfer function information data structure.

Another embodiment of the present invention discloses a device for rendering a video asset included in a multimedia presentation, the device comprising one or more processors configured to: receive a descriptor associated with a video asset; parse color information corresponding to the video asset based on a flag indicating color information is present in the descriptor; parse a flag indicating whether electro-optical transfer function information data structure is present based on whether a code value including in the color information is greater than a predetermined value; parse a flag indicating whether an electro-optical transfer function information data structure is present based on a value of the flag indicating whether electro-optical transfer function information data structure is present; based on a value of the flag indicating whether an electro-optical transfer function information data structure is present: parse a syntax element indicating a length in bytes of an electro-optical transfer function information data structure; and parse an electro-optical transfer function information data structure corresponding to the syntax element indicating a length in bytes of an electro-optical transfer function information data structure.

Another embodiment of the present invention discloses a method for determining one or parameters of a video asset included in a multimedia presentation, the method comprising: receiving a descriptor associated with a video asset; and parsing electro-optical transfer function information, wherein parsing electro-optical transfer function information includes parsing a syntax element indicating the length in bytes of an electro-optical transfer function information data structure.

### BRIEF DESCRIPTION OF DRAWINGS

FIG. 1 is a conceptual diagram illustrating an example of content delivery protocol model according to one or more techniques of this disclosure.

FIG. 2 is a conceptual diagram illustrating an example of generating a signal for distribution over a unidirectional communication network according to one or more techniques of this disclosure.

FIG. 3 is a conceptual diagram illustrating an example of encapsulating encoded video data into a transport package according to one or more techniques of this disclosure.

FIG. 4 is a block diagram illustrating an example of a system that may implement one or more techniques of this disclosure.

FIG. 5 is a block diagram illustrating an example of a service distribution engine that may implement one or more techniques of this disclosure.

FIG. 6 is a block diagram illustrating an example of a transport package generator that may implement one or more techniques of this disclosure.

FIG. 7 is a block diagram illustrating an example of a receiver device that may implement one or more techniques of this disclosure.

### DESCRIPTION OF EMBODIMENTS

In general, this disclosure describes techniques for signaling video parameters associated with a multimedia presentation. In particular, this disclosure describes techniques for signaling video parameters using a media transport protocol. In one example, video parameters may be signaled within a message table encapsulated within a transport package logical structure. The techniques described herein may enable efficient transmission of data. The techniques described herein may be particular useful for multimedia presentations including multiple video elements (which may be referred to as streams in some examples). Examples of multimedia presentations including multiple video elements include multiple camera view presentations, three dimensional presentations through multiple views, temporal scalable video presentations, spatial and quality scalable video presentations. It should be noted that although in some examples the techniques of this disclosure are described with respect to ATSC standards and High Efficiency Video Compression (HEVC) standards, the techniques described herein are generally applicable to any transmission standard. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband (HbbTV) standard, World Wide Web Consortium (W3C) standards, Universal Plug and Play (UPnP) standards, and other video encoding standards. Further, it should be noted that incorporation by reference of documents herein should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

According to one example of the disclosure, a method for signaling video parameters using a media transport protocol, comprises signaling a syntax element providing information specifying constraints associated with a layer of encoded video data, signaling one or more flags indicating whether a type of information associated with the layer of encoded video data is signaled, and signaling respective semantics providing information associated with the layer of encoded video data based on the one or flags.

According to another example of the disclosure, a device for signaling video parameters using a media transport protocol comprises one or more processors configured to signal a syntax element providing information specifying constraints associated with a layer of encoded video data, signal one or more flags indicating whether a type of information associated with the layer of encoded video data is signaled, and signal respective semantics providing information associated with the layer of encoded video data based on the one or flags.

According to another example of the disclosure, an apparatus for signaling video parameters using a media transport protocol comprises means for signaling a syntax element providing information specifying constraints associated with a layer of encoded video data, means for signaling one or more flags indicating whether a type of information associated with the layer of encoded video data is signaled, and means for signaling respective semantics providing information associated with the layer of encoded video data based on the one or flags.

According to another example of the disclosure, a non-transitory computer-readable storage medium comprises instructions stored thereon that upon execution cause one or more processors of a device to signal a syntax element providing information specifying constraints associated with a layer of encoded video data, signal one or more flags indicating whether a type of information associated with the layer of encoded video data is signaled, and signal respective semantics providing information associated with the layer of encoded video data based on the one or flags.

The details of one or more examples are set forth in the accompanying drawings and the description below. Other features, objects, and advantages will be apparent from the description and drawings, and from the claims.

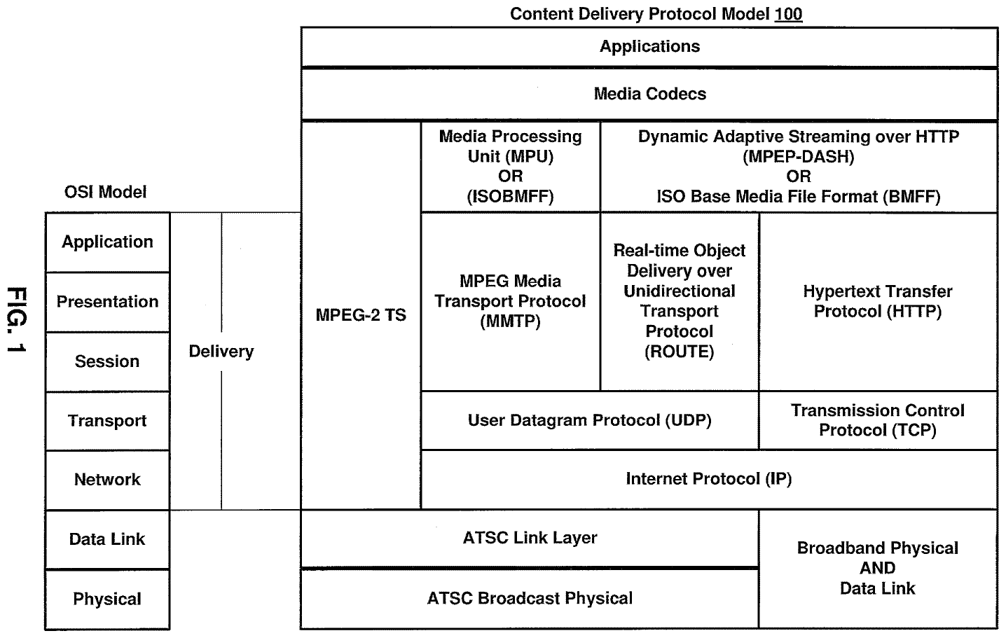

Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model illustrated in FIG. 1. The OSI model defines a 7-layer stack model, including an application layer, a presentation layer, a session layer, a transport layer, a network layer, a data link layer, and a physical layer. A physical layer may generally refer to a layer at which electrical signals form digital data. For example, a physical layer may refer to a layer that defines how modulated radio frequency (RF) symbols form a frame of digital data. A data link layer, which may also be referred to as link layer, may refer to an abstraction used prior to physical layer processing at a sending side and after physical layer reception at a receiving side. It should be noted that a sending side and a receiving side are logical roles and a single device may operate as both a sending side in one instance and as a receiving side in another instance. Each of an application layer, a presentation layer, a session layer, a transport layer, and a network layer may define how data is delivered for use by a user application.

Transmission standards may include a content delivery protocol model specifying supported protocols for each layer and further defining one or more specific layer implementations. For example, ATSC Standards: System Discovery and Signaling Doc. A/321:2016, 23 Mar. 2016 (hereinafter “A/321”); Physical Layer Protocol Doc. A/322:2016, 7 Sep. 2016 (hereinafter “A/322”); and Link-Layer Protocol Doc. A/3330:2016, 19 Sep. 2016 (hereinafter “A/330”), each of which are incorporated by reference in their respective its entirety, describe specific aspects of an ATSC 3.0 unidirectional physical layer implementation and a corresponding link layer. The link layer abstracts various types of data encapsulated in particular packet types (e.g., MPEG-Transport Stream (TS) packets, IPv4 packets, etc.) into a single generic format for processing by a physical layer. Additionally, the link layer supports segmentation of a single upper layer packet into multiple link layer packets and concatenation of multiple upper layer packets into a single link layer packet. Further, aspects of the ATSC 3.0 suite of standards currently under development are described in Proposed Standards, Candidate Standards, revisions thereto, and Working Drafts (WD), each of which may include proposed aspects for inclusion in a published (i.e., “final” or “adopted”) version of an ATSC 3.0 standard.

The proposed ATSC 3.0 suite of standards also support so-called broadband physical layers and data link layers to enable support for hybrid video services. For example, it may be desirable for a primary presentation of a sporting event to be received by a receiving device through an over-the-air broadcast and a second video presentation associated with the sporting event (e.g., a team specific second camera view or an enhanced presentation) to be received from a stream provided by an online media service provider. Higher layer protocols may describe how the multiple video services included in a hybrid video service may be synchronized for presentation. It should be noted that although ATSC 3.0 uses the term “broadcast” to refer to a unidirectional over-the-air transmission physical layer, the so-called ATSC 3.0 broadcast physical layer supports video delivery through streaming or file download. As such, the term broadcast as used herein should not be used to limit the manner in which video and associated data may be transported according to one or more techniques of this disclosure.

Referring again to FIG. 1, an example content delivery protocol model is illustrated. In the example illustrated in FIG. 1, content delivery protocol model 100 is “aligned” with the 7-layer OSI model for illustration purposes. It should be noted however that such an illustration should not be construed to limit implementations of the content delivery protocol model 100 or the techniques described herein. Content delivery protocol model 100 may generally correspond to the current content delivery protocol model proposed for the ATSC 3.0 suite of standard. However, as described in detail below, the techniques described herein may be incorporated into a system implementation of content delivery protocol model 100 in order to enable and/or enhance functionality in an interactive video distribution environment.

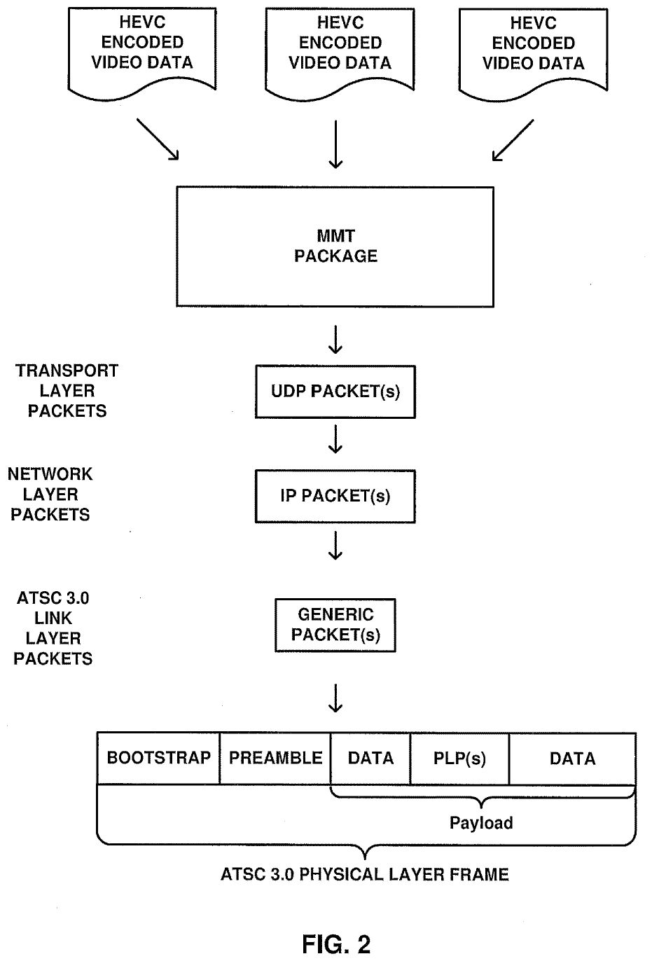

Referring to FIG. 1, content delivery protocol model 100 includes two options for supporting streaming and/or file download through ATSC Broadcast Physical layer: (1) MPEG Media Transport Protocol (MMTP) over User Datagram Protocol (UDP) and Internet Protocol (IP) and (2) Real-time Object delivery over Unidirectional Transport (ROUTE) over UDP and IP. An overview of ROUTE is provided in ATSC Candidate Standard: Signaling, Delivery, Synchronization, and Error Protection (A/331) Doc. S33-1-654r4-Signaling-Delivery-Sync-FEC, approved 4 Oct. 2016, Updated 6 Jan. 2017 (hereinafter “A/331”), which is incorporated by reference in its entirety. MMTP is described in ISO/IEC: ISO/IEC 23008-1, “Information technology-High efficiency coding and media delivery in heterogeneous environments—Part 1: MPEG media transport (MMT),” which is incorporated by reference herein in its entirety. As illustrated in FIG. 1, in the case where MMTP is used for streaming video data, video data may be encapsulated in a Media Processing Unit (MPU). MMTP defines a MPU as “a media data item that may be processed by an MMT entity and consumed by the presentation engine independently from other MPUs.” As illustrated in FIG. 2 and described in further detail below, a logical grouping of MPUs may form an MMT asset, where MMTP defines an asset as “any multimedia data to be used for building a multimedia presentation. An asset is a logical grouping of MPUs that share the same asset identifier for carrying encoded media data.” One or more assets may form a MMT package, where a MMT package is a logical collection of multimedia content. As further illustrated in FIG. 1, in the case where MMTP is used for downloading video data, video data may be encapsulated in an International Standards Organization (ISO) based media file format (ISOBMFF). An example of an ISOBMFF is described in ISO/IEC FDIS 14496-15:2014(E): Information technology—Coding of of audio-visual objects—Part 15: Carriage of network abstraction layer (NAL) unit structured video in ISO base media file format (“ISO/IEC 14496-15”), which is incorporated by reference in its entirety. MMTP describes a so-called ISOBMFF-based MPU. In this case, an MPU may include a conformant ISOBMFF file.

As described above, the ATSC 3.0 suite of standards seeks to support multimedia presentations including multiple video elements. Examples of multimedia presentations including multiple video elements include multiple camera views (e.g., sport event example described above), three dimensional presentations through multiple views (e.g., left and right video channels), temporal scalable video presentations (e.g., a base frame rate video presentation and enhanced frame rate video presentations), spatial and quality scalable video presentations (a High Definition video presentation and an Ultra High Definition video presentation), multiple audio presentations (e.g., native language in a primary presentation and other audio tracks in other presentations), and the like.

Digital video may be encoded according to a video coding standard. One example video coding standard includes the so-called High-Efficiency Video Coding (HEVC) standard. As used herein, an HEVC video coding standard may include final and draft versions of the HEVC video coding standard and various draft and/or final extensions thereof. As used herein, the term HEVC video coding standard may be inclusive of ITU-T, “High Efficiency Video Coding,” Recommendation ITU-T H.265 (April 2015) (herein “ITU-T H.265”) maintained by the International Telecommunication Union (ITU) and corresponding ISO/IEC 23008-2 MPEG-H maintained by ISO, each of which are incorporated by reference in their entirety. It should be noted that although HEVC is described herein with reference to ITU-T H.265, such descriptions should not be construed to limit scope of the techniques described herein.

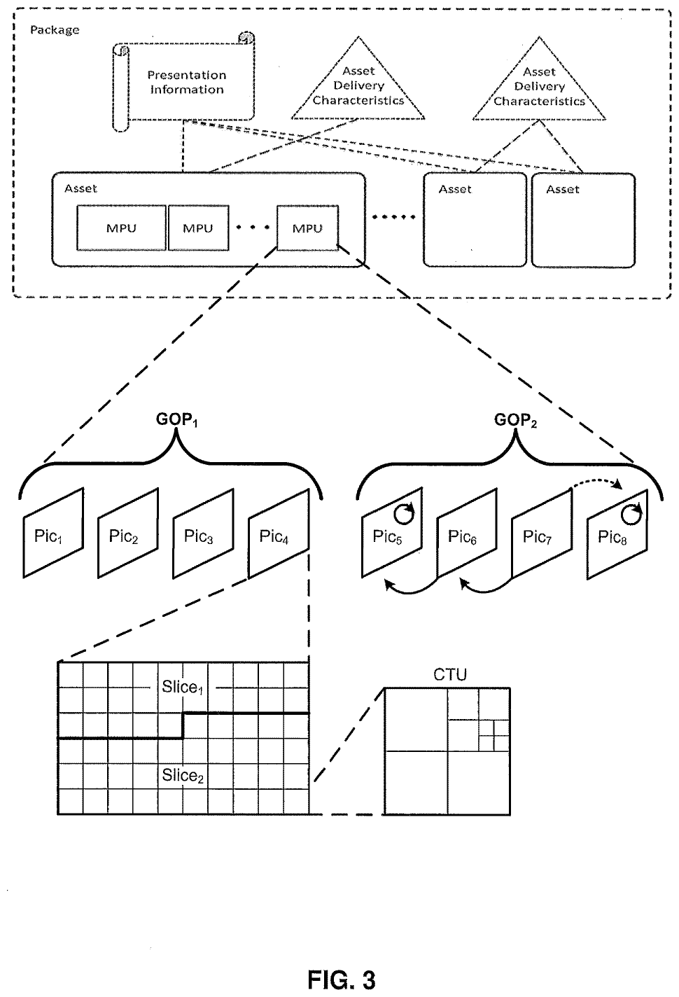

Video content typically includes video sequences comprised of a series of frames. A series of frames may also be referred to as a group of pictures (GOP). Each video frame or picture may include a plurality of slices, where a slice includes a plurality of video blocks. A video block may be defined as the largest array of pixel values (also referred to as samples) that may be predictively coded. Video blocks may be ordered according to a scan pattern (e.g., a raster scan). A video encoder may perform predictive encoding on video blocks and sub-divisions thereof. HEVC specifies a coding tree unit (CTU) structure where a picture may be split into CTUs of equal size and each CTU may include coding tree blocks (CTB) having 16×16, 32×32, or 64×64 luma samples. An example of partitioning a group of pictures into CTBs is illustrated in FIG. 3.

As illustrated in FIG. 3, a video sequence includes GOP₁ and GOP₂, where pictures Pic₁-Pic₄ are included in GOP₁ and pictures Pic₅-Pic₈ are included in GOP₂. Pic₄ is partitioned into Slice₁ and Slice₂, where each of Slice₁ and Slice₂ include consecutive CTUs according to a left-to-right top-to-bottom raster scan. FIG. 3 also illustrates the concept of I slices, P slices, or B slices with respect to GOP₂. The arrows associated with each of Pic₅-Pic₈ in GOP₂ indicate whether a picture includes intra prediction (I) slices, unidirectional inter prediction (P) slices, or bidirectional inter prediction (B) slices. In FIG. 3 pictures Pic₅ and Pic₈ represent pictures including I slices (i.e., references are within the picture itself), picture Pic₆ represents a picture including P slices (i.e., each reference a previous picture) and picture Pic₇ represents a picture including B slices (i.e., references a previous and a subsequent picture).

ITU-T H.265 defines support for multi-layer extensions, including format range extensions (RExt) (described in Annex A of ITU-T H.265), scalability (SHVC) (described in Annex H of ITU-T H.265), and multi-view (MV-HEVC) (described in Annex G of ITU-T H.265). In ITU-T H.265 in order to support multi-layer extensions a picture may reference a picture from a group of pictures other than the group of pictures the picture is included in (i.e., may reference another layer). For example, an enhancement layer (e.g., a higher quality) picture may reference a picture from a base layer (e.g., a lower quality picture). Thus, it some examples, in order to provide multiple video presentations it may be desirable to include multiple ITU-T H.265 coded video sequences in a MMT package.

FIG. 2 is a conceptual diagram illustrating an example of encapsulating sequences of HEVC encoded video data in a MMT package for transmission using an ATSC 3.0 physical frame. In the example illustrated in FIG. 2, a plurality of encoded video data layers are encapsulated in a MMT package. FIG. 3 includes additional detail of an example of how HEVC encoded video data may be encapsulated in a MMT package. The encapsulation of video data, including HEVC video data, in a MMT package is described in greater detail below. Referring again to FIG. 2, the MMT package is encapsulated into network layer packets, e.g., IP data packet(s). Network layer packets are encapsulated into link layer packets, i.e., generic packet(s). Network layer packets are received for physical layer processing. In the example illustrated in FIG. 2, physical layer processing includes encapsulating generic packet(s) in a physical layer pipe (PLP). In one example, a PLP may generally refer to a logical structure including all or portions of a data stream. In the example illustrated in FIG. 2, the PLP is included within the payload of a physical layer frame.

In HEVC each of a video sequence, a GOP, a picture, a slice, and CTU may be associated with syntax data that describes video coding properties. For example, ITU-T H.265 provides the following parameter sets:
video parameter set (VPS): A syntax structure containing syntax elements that apply to zero or more entire coded video sequences (CVSs) as determined by the content of a syntax element found in the SPS referred to by a syntax element found in the PPS referred to by a syntax element found in each slice segment header.
sequence parameter set (SPS): A syntax structure containing syntax elements that apply to zero or more entire CVSs as determined by the content of a syntax element found in the PPS referred to by a syntax element found in each slice segment header.
picture parameter set (PPS): A syntax structure containing syntax elements that apply to zero or more entire coded pictures as determined by a syntax element found in each slice segment header.

where a coded video sequence includes a sequence of access units, where in ITU-T H.265 a sequence of access units is defined based on the following definitions:
access unit: A set of NAL units that are associated with each other according to a specified classification rule, . . . consecutive in decoding order . . .
network abstraction layer (NAL) unit: A syntax structure containing an indication of the type of data to follow and bytes containing that data in the form of an raw byte sequence payload (RBSP) interspersed as necessary with emulation prevention bytes.
layer: A set of video coding layer (VCL) NAL units that all have a particular value of nuh_layer_id and the associated non-VCL NAL units, or one of a set of syntactical structures having a hierarchical relationship.

It should be noted that the term “access unit” as used with respect ITU-T H.265 should not be confused with the term “access unit” used with respect to MMT. As used herein the term access unit may refer either to an ITU-T H.265 access unit, a MMT access unit, or may more generally refer to a data structure. In ITU-T H.265 in some instances parameter sets may be encapsulated as a special type of NAL unit or may be signaled as a message. In some instances, it may be beneficial for a receiving device to be able to access to video parameters prior to decapsulating NAL units or ITU-T H.265 messages. Further, in some cases, syntax elements included in ITU-T H.265 parameters sets may include information that is not useful for a particular type of receiving device or application. The techniques described herein provide video parameter signaling techniques that may increase transmission efficiency and processing efficiency at a receiving device. Increasing transmission efficiency may result in significant cost savings for network operators. It should be noted that although the techniques described herein are described with respect to MMTP, the techniques described herein are general applicable regardless of a particular applicant transport layer implementation.

ISO/IEC 14496-15 specifies formats of elementary streams for storing a set of Network Abstraction Layer (NAL) units defined according to a video coding standard (e.g., NAL units as defined by ITU-T H.265). In ISO/IEC 14496-15 a stream is represented by one or more tracks in a file. A track in ISO/IEC 14496-15 may generally correspond to a layer as defined in ITU-T H.265. In ISO/IEC 14496-15 tracks include samples, where a sample is defined as follows:
Sample: A sample is an access unit or a part of an access unit, where an access unit is as defined in the appropriate specification (e.g., ITU-T H.265).

In ISO/IEC 14496-15 tracks may be defined based on constraints with respect to the types of NAL units included therein. That is, in ISO/IEC 14496-15, a particular type of track may be required to include particular types of NAL units, may optionally include other types of NAL units, and/or may be prohibited from including particular types of NAL units. For example, in ISO/IEC 14496-15 tracks included in a video stream may be distinguished based on whether or not a track is allowed to include parameter set (e.g., VPS, SPS, and PPS described above). For example, ISO/IEC 14496-15 provides the following with respect to an HEVC video stream “for a video stream that a particular sample entry applies to, the video parameter set, sequence parameter sets, and picture parameter sets, shall be stored only in the sample entry when the sample entry name is ‘hvc1’, and may be stored in the sample entry and the samples when the sample entry name is ‘hev1’.” In this example, a ‘hvc1’ access unit is required to includes NALs of types that include parameter sets and ‘hev1’ access unit may, but is not required to include NAL of types that include parameter set.

As described above, ITU-T H.265 defines support for multi-layer extensions. ISO/IEC 14496-15 defines an L-HEVC stream structure that is represented by one or more video tracks in a file, where each track represents one or more layers of the coded bitstream. Tracks included in an L-HEVC stream may be defined based on constraints with respect to the types of NAL units included therein. Table 1A below provides a summary of example of track types for HEVC and L-HEVC stream structures (i.e. configurations) in ISO/IEC 14496-15.

TABLE 1A

| | Applicable | |
|---|---|---|
| Track Type | Configuration | Meaning |
| ‘hvc1’ or ‘hev1’ | HEVC | A plain HEVC track without NAL |
| | Configuration | units with nuh_layer_id greater |
| | Only | than 0; Extractors and aggregators |
| | | shall not be present. |
| ‘hvc1’ or ‘hev1’ | HEVC and | An L-HEVC track with both NAL |
| | L-HEVC | units with nuh_layer_id equal to |
| | Configurations | 0 and NAL units with nuh_layer_id |
| | | greater than 0; Extractors and |
| | | aggregators may be present; |
| | | Extractors shall not reference NAL |
| | | units with nub layer _id equal to 0; |
| | | Aggregators shall not contain but |
| | | may reference NAL units with |
| | | nuh_layer id equal to 0. |
| ‘hvc2’ or ‘hev2’ | HEVC | A plain HEVC track without NAL |
| | Configuration | units with nuh_layer_id greater than |
| | Only | 0; Extractors may be present and |
| | | used to reference NAL units; |
| | | Aggregators may be present to |
| | | contain and reference NAL units. |
| ‘hvc2’ or ‘hev2’ | HEVC and | An L-HEVC track with both NAL |
| | L-HEVC | units with nuh_layer_id equal to |
| | Configurations | 0 and NAL units with nuh_layer_id |
| | | greater than 0; Extractors and |
| | | aggregators may be present; |
| | | Extractors may reference any NAL |
| | | units; Aggregators may both contain |
| | | and reference any NAL units. |
| ‘lhv1’ or ‘lhe1' | L-HEVC | An L-HEVC track without NAL |
| | Configuration | units with nuh_layer_id equal to 0; |
| | Only | Extractors may be present and used |
| | | to reference NAL units; Aggregators |
| | | may be present to contain and |
| | | reference NAL units. |

In Table 1A, aggregators may generally refer to data that may be used to group NAL units that belong to the same sample (e.g., access unit) and extractors may generally refer to data that may be used to extract data from other tracks. A nuh_layer_id refers to an identifier that specifies the layer to which a NAL unit belongs. In one example, nuh_layer_id in Table 1A may be based on nuh_layer_id as defined in ITU-T H.265. IUT-U H.265 defines nuh_layer_id as follows:
nuh_layer_id specifies the identifier of the layer to which a VCL NAL unit belongs or the identifier of a layer to which a non-VCL NAL unit applies. The value of nuh_layer_id shall be in the range of 0 to 62, inclusive.

It should be noted that a nuh_layer_id value of 0 typically corresponds to a base layer and a nuh_layer_id greater than 0 typically corresponds to an enhancement layer. For the sake of brevity, a complete description of each of the track types included in Table 1A is not provided herein, however, reference is made to ISO/IEC 14496-15. Referring to FIG. 1, ATSC 3.0 may support an MPEG-2 TS, where an MPEG-2 TS, refers to an MPEG-2 Transport Stream (TS) and may include a standard container format for transmission and storage of audio, video, and Program and System Information Protocol (PSIP) data. ISO/IEC 13818-1, (2013), “Information Technology—Generic coding of moving pictures and associated audio—Part 1: Systems,” including FDAM 3—“Transport of HEVC video over MPEG-2 systems,” described the carriage of HEVC bitstreams over MPEG-2 Transport Streams.

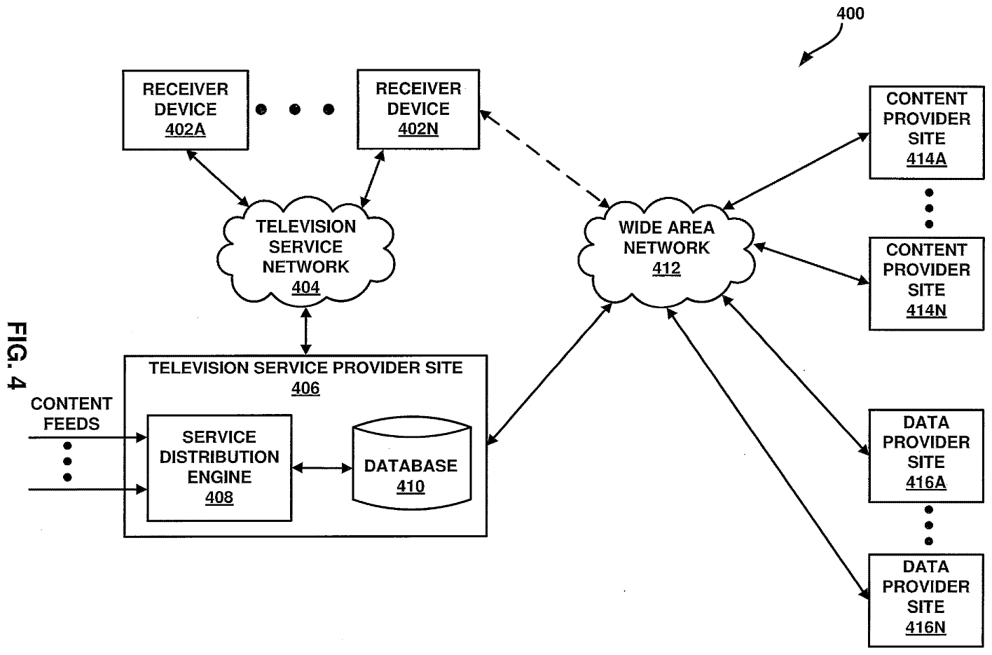

FIG. 4 is a block diagram illustrating an example of a system that may implement one or more techniques described in this disclosure. System 400 may be configured to communicate data in accordance with the techniques described herein. In the example illustrated in FIG. 4, system 400 includes one or more receiver devices 402A-402N, television service network 404, television service provider site 406, wide area network 412, one or more content provider sites 414A-414N, and one or more data provider sites 416A-416N. System 400 may include software modules. Software modules may be stored in a memory and executed by a processor. System 400 may include one or more processors and a plurality of internal and/or external memory devices. Examples of memory devices include file servers, file transfer protocol (FTP) servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 400 represents an example of a system that may be configured to allow digital media content, such as, for example, a movie, a live sporting event, etc., and data and applications and multimedia presentations associated therewith, to be distributed to and accessed by a plurality of computing devices, such as receiver devices 402A-402N. In the example illustrated in FIG. 4, receiver devices 402A-402N may include any device configured to receive data from television service provider site 406. For example, receiver devices 402A-402N may be equipped for wired and/or wireless communications and may include televisions, including so-called smart televisions, set top boxes, and digital video recorders. Further, receiver devices 402A-402N may include desktop, laptop, or tablet computers, gaming consoles, mobile devices, including, for example, “smart” phones, cellular telephones, and personal gaming devices configured to receive data from television service provider site 406. It should be noted that although system 400 is illustrated as having distinct sites, such an illustration is for descriptive purposes and does not limit system 400 to a particular physical architecture. Functions of system 400 and sites included therein may be realized using any combination of hardware, firmware and/or software implementations.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of receiver devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 4, television service provider site 406 may be configured to distribute television service via television service network 404. For example, television service provider site 406 may include one or more broadcast stations, a cable television provider, or a satellite television provider, or an Internet-based television provider. In the example illustrated in FIG. 4, television service provider site 406 includes service distribution engine 408 and database 410. Service distribution engine 408 may be configured to receive data, including, for example, multimedia content, interactive applications, and messages, and distribute data to receiver devices 402A-402N through television service network 404. For example, service distribution engine 408 may be configured to transmit television services according to aspects of the one or more of the transmission standards described above (e.g., an ATSC standard). In one example, service distribution engine 408 may be configured to receive data through one or more sources. For example, television service provider site 406 may be configured to receive a transmission including television programming through a satellite uplink/downlink Further, as illustrated in FIG. 4, television service provider site 406 may be in communication with wide area network 412 and may be configured to receive data from content provider sites 414A-414N and further receive data from data provider sites 416A-416N. It should be noted that in some examples, television service provider site 406 may include a television studio and content may originate therefrom.

Database 410 may include storage devices configured to store data including, for example, multimedia content and data associated therewith, including for example, descriptive data and executable interactive applications. For example, a sporting event may be associated with an interactive application that provides statistical updates. Data associated with multimedia content may be formatted according to a defined data format, such as, for example, Hypertext Markup Language (HTML), Dynamic HTML, eXtensible Markup Language (XML), and JavaScript Object Notation (JSON), and may include Universal Resource Locators (URLs) and Uniform Resource Identifiers (URI) enabling receiver devices 402A-402N to access data, e.g., from one of data provider sites 416A-416N. In some examples, television service provider site 406 may be configured to provide access to stored multimedia content and distribute multimedia content to one or more of receiver devices 402A-402N through television service network 404. For example, multimedia content (e.g., music, movies, and television (TV) shows) stored in database 410 may be provided to a user via television service network 404 on a so-called on demand basis.

Wide area network 412 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 412 may comprise any combination of wireless and/or wired communication media. Wide area network 412 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 412 may include the Internet.

Referring again to FIG. 4, content provider sites 414A-414N represent examples of sites that may provide multimedia content to television service provider site 106 and/or receiver devices 402A-402N. For example, a content provider site may include a studio having one or more studio content servers configured to provide multimedia files and/or streams to television service provider site 406. In one example, content provider sites 414A-414N may be configured to provide multimedia content using the IP suite. For example, a content provider site may be configured to provide multimedia content to a receiver device according to Real Time Streaming Protocol (RTSP), or Hyper-Text Transport Protocol (HTTP).

Data provider sites 416A-416N may be configured to provide data, including hypertext based content, and the like, to one or more of receiver devices 402A-402N and/or television service provider site 406 through wide area network 412. A data provider site 416A-416N may include one or more web servers. Data provided by data provider site 416A-416N may be defined according to data formats, such as, for example, HTML, Dynamic HTML, XML, and JSON. An example of a data provider site includes the United States Patent and Trademark Office website. It should be noted that in some examples, data provided by data provider sites 416A-416N may be utilized for so-called second screen applications. For example, companion device(s) in communication with a receiver device may display a website in conjunction with television programming being presented on the receiver device. It should be noted that data provided by data provider sites 416A-416N may include audio and video content.

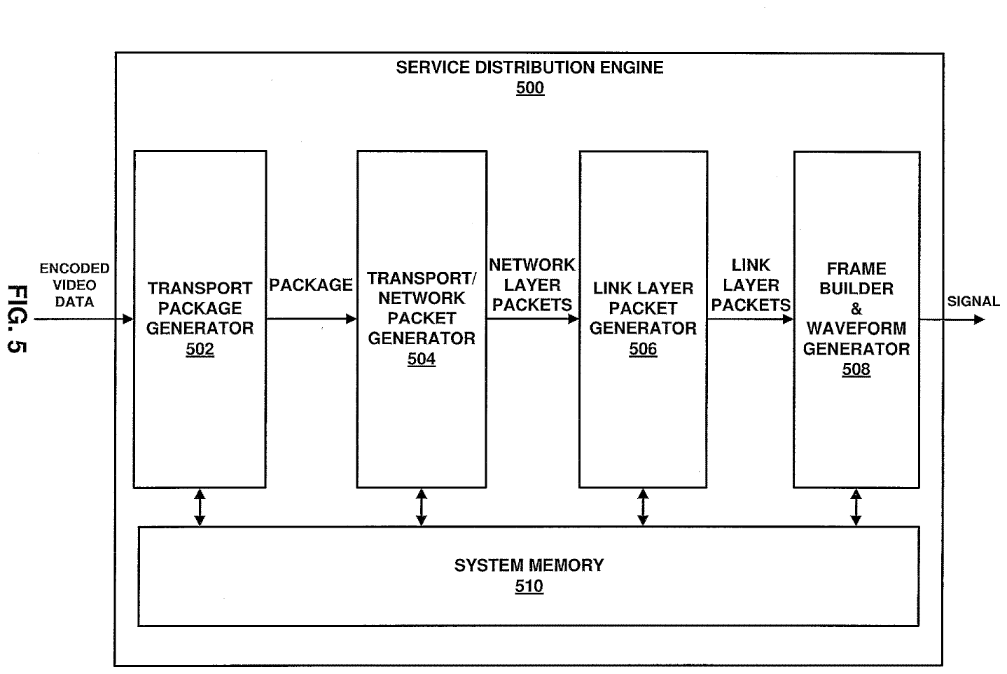

As described above, service distribution engine 408 may be configured to receive data, including, for example, multimedia content, interactive applications, and messages, and distribute data to receiver devices 402A-402N through television service network 404. FIG. 5 is a block diagram illustrating an example of a service distribution engine that may implement one or more techniques of this disclosure. Service distribution engine 500 may be configured to receive data and output a signal representing that data for distribution over a communication network, e.g., television service network 404. For example, service distribution engine 500 may be configured to receive one or more data streams and output a signal that may be transmitted using a single radio frequency band (e.g., a 6 MHz channel, an 8 MHz channel, etc.) or a bonded channel (e.g., two separate 6 MHz channels). A data stream may generally refer to data encapsulated in a set of one or more data packets. In the example illustrated in FIG. 5, service distribution engine 500 is illustrated as receiving encoded video data. As described above, encoded video data may include one or more layers of HEVC encoded video data.

As illustrated in FIG. 5, service distribution engine 500 includes transport package generator 502, transport/network packet generator 504, link layer packet generator 506, frame builder and waveform generator 508, and system memory 510. Each of transport package generator 502, transport/network packet generator 504, link layer packet generator 506, frame builder and waveform generator 508, and system memory 510 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although service distribution engine 500 is illustrated as having distinct functional blocks, such an illustration is for descriptive purposes and does not limit service distribution engine 500 to a particular hardware architecture. Functions of service distribution engine 500 may be realized using any combination of hardware, firmware and/or software implementations.

System memory 510 may be described as a non-transitory or tangible computer-readable storage medium. In some examples, system memory 510 may provide temporary and/or long-term storage. In some examples, system memory 510 or portions thereof may be described as non-volatile memory and in other examples portions of system memory 510 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. System memory 510 may be configured to store information that may be used by service distribution engine 500 during operation. It should be noted that system memory 510 may include individual memory elements included within each of transport package generator 502, transport/network packet generator 504, link layer packet generator 506, and frame builder and waveform generator 508. For example, system memory 510 may include one or more buffers (e.g., First-in First-out (FIFO) buffers) configured to store data for processing by a component of service distribution engine 500.

Transport package generator 502 may be configured to receive one or more layers of encoded video data and generate a transport package according to a defined applicant transport package structure. For example, transport package generator 502 may be configured to receive one or more HEVC layers of encoded video data and generate a package based on MMTP, as described in detail below. Transport/network packet generator 504 may be configured to receive a transport package and encapsulate the transport package into corresponding transport layer packets (e.g., UDP, Transport Control Protocol (TCP), etc.) and network layer packets (e.g., IPv4, IPv6, compressed IP packets, etc.). Link layer packet generator 506 may be configured to receive network packets and generate packets according to a defined link layer packet structure (e.g., an ATSC 3.0 link layer packet structure).

Frame builder and waveform generator 508 may be configured to receive one or more link layer packets and output symbols (e.g., OFDM symbols) arranged in a frame structure. As described above, a frame may include one or more PLPs may be referred to as a physical layer frame (PHY-Layer frame). In one example, a frame structure may include a bootstrap, a preamble, and a data payload including one or more PLPs. A bootstrap may act as a universal entry point for a waveform. A preamble may include so-called Layer-1 signaling (L1-signaling). L1-signaling may provide the necessary information to configure physical layer parameters. Frame builder and waveform generator 508 may be configured to produce a signal for transmission within one or more of types of RF channels: a single 6 MHz channel, a single 7 MHz channel, single 8 MHz channel, a single 11 MHz channel, and bonded channels including any two or more separate single channels (e.g., a 14 MHz channel including a 6 MHz channel and a 8 MHz channel). Frame builder and waveform generator 508 may be configured to insert pilots and reserved tones for channel estimation and/or synchronization. In one example, pilots and reserved tones may be defined according to an OFDM symbol and sub-carrier frequency map. Frame builder and waveform generator 508 may be configured to generate an OFDM waveform by mapping OFDM symbols to sub-carriers. It should be noted that in some examples, frame builder and waveform generator 508 may be configured to support layer division multiplexing. Layer division multiplexing may refer to super-imposing multiple layers of data on the same RF channel (e.g., a 6 MHz channel). Typically, an upper layer refers to a core (e.g., more robust) layer supporting a primary service and a lower layer refers to a high data rate layer supporting enhanced services. For example, an upper layer could support basic High Definition video content and a lower layer could support enhanced Ultra-High Definition video content.

As described above, in order to provide multimedia presentations including multiple video elements, it may be desirable to include multiple HEVC coded video sequences in a MMT package. As provided in ISO/IEC 23008-1, MMT content is composed of Media Fragment Units (MFU), MPUs, MMT assets, and MMT Packages. In order to produce MMT content, encoded media data is decomposed into MFUs, where MFUs may correspond to access units or slices of encoded video data or other units, which can be independently decoded. One or more MFUs may be combined into a MPU. As described above, a logical grouping of MPUs may form an MMT asset and one or more assets may form a MMT package.

Referring to FIG. 3, in addition to including one or more assets, a MMT package includes presentation information (PI) and asset delivery characteristics (ADC). Presentation information includes documents (PI documents) that specify the spatial and temporal relationship among the assets. In some cases, a PI document may be used to determine the delivery order of assets in a package. A PI document may be delivered as one or more signaling messages. Signaling messages may include one or more tables. Asset delivery characteristics describe the quality of service (QoS) requirements and statistics of assets for delivery. As illustrated in FIG. 3, multiple assets can be associated with a single ADC.

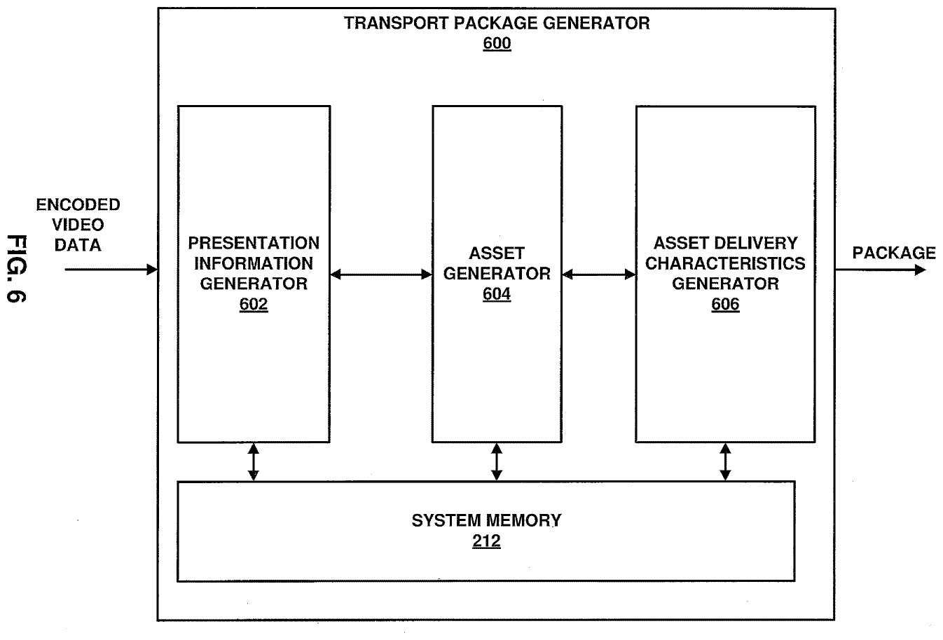

FIG. 6 is a block diagram illustrating an example of a transport package generator that may implement one or more techniques of this disclosure. Transport package generator 600 may be configured to generate a package according to the techniques described herein. As illustrated in FIG. 6, transport package generator 600 includes presentation information generator 602, asset generator 604, and asset delivery characteristic generator 606. Each of presentation information generator 602, asset generator 604, and asset delivery characteristic generator 606 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although transport package generator 600 is illustrated as having distinct functional blocks, such an illustration is for descriptive purposes and does not limit transport package generator 600 to a particular hardware architecture. Functions of transport package generator 600 may be realized using any combination of hardware, firmware and/or software implementations.

Asset generator 604 may be configured to receive encoded video data and generate one or more assets for inclusion in a package. Asset delivery characteristic generator 606 may be configured to receive information regarding assets to be included in a package and provide QoS requirements. Presentation information generator 602 may be configured to generate presentation information documents. As described above, in some instances, it may be beneficial for a receiving device to be able to access video parameters prior to decapsulating NAL units or HEVC bitstream data. In one example, transport package generator 600 and/or presentation information generator 602 may be configured to include one or more video parameters in presentation information of a package.

As described above, a presentation information document may be delivered as one or more signaling messages which may include one or more tables. One example table includes a MMT Package Table (MPT), where a MPT message is defined in ISO/IEC 23008-1 as “this message type contains an MP (MPT message) table that provides all or a part of information required for a single package consumption.” Example semantics for an MP table is provided in Table 1B below.

TABLE 1B

| | | No. of | |
|---|---|---|---|
| Syntax | Value | bits | Mnemonic |
| MP_table( ) { | | | |
| table_id | | 8 | uimsbf |
| version | | 8 | uimsbf |
| length | | 16 | uimsbf |
| reserved | ‘11 1111’ | 6 | bslbf |
| MP_table_mode | | 2 | bslbf |
| If (table _id == | | | |
| SUBSET_0_MPT_TABLE_ID) { | N1 | | |
| MMT_package_id { | | 8 | uimsbf |
| MMT_package_id_length | | | |
| for (i=0; i<N1; i++) { | | 8 | uimsbf |
| MMT_package_id_byte | | | |
| } | | | |
| } | | | |
| } | N2 | | |
| MP_table_descriptors { | | 16 | uimsbf |
| MP_table_descriptors_length | | | |
| for (i=0; i<N2; i++) { | | 8 | uimsbf |
| MP_table_descriptors_byte | | | |
| } | | | |
| } | | | |
| } | N3 | 8 | uimsbf |
| number_of_assets | | | |
| for (1=0; i<N3; i++) { | | | |
| Identifier mapping( ) | | 32 | char |
| asset_type | ‘1111 11’ | 6 | bslbf |
| reserved | | 1 | bslbf |
| default_asset_flag | | 1 | bslbf |
| asset_clock_relation_flag | | | |
| if (asset_clock_relation_flag == 1) { | | 8 | uimsbf |
| asset_clock_relation_id | ‘1111 111’ | 7 | bslbf |
| reserved | | 1 | bslbf |
| asset_timescale_flag | | | |
| if (asset_time_scale_flag == 1) { | | 32 | uimsbf |
| asset timescale | | | |
| } | | | |
| } | | | |
| asset location { | | | |
| | N6 | 8 | uimsbf |
| location_count | | | |
| for (i=0; i<N6; i++) { | | | |
| MMT_general_location_info( ) | | | |
| } | | | |
| } | N5 | 16 | uimsbf |
| asset_descriptors { | | | |
| asset_descriptors_length | | 8 | uimsbf |
| for (j=0; j<N5; j++) { | | | |
| asset_descriptors_byte | | | |
| } | | | |
| } | | | |
| } | | | |
| } | | | |

Each of the syntax elements in Table 1B are described in ISO/IEC 23008-1 (e.g., with respect to Table 20 in ISO/IEC 23008-1). For the sake of brevity, a complete description of each of the syntax elements included in Table 1B is not provided herein, however, reference is made to ISO/IEC 23008-1. In Table 1B and the tables below uimsbf refers to an unsigned integer most significant bit first data type, bslbf refers to bit string left bit first data type, and char refers to a character data type. ISO/IEC 23008-1 provides the following with respect to asset_descriptors_length and asset_descriptors_byte:
asset_descriptors_length—the number of bytes counted from the beginning of the next field to the end of the asset descriptors syntax loop.
asset_descriptors_byte—a byte in asset descriptors.

Thus, asset_descriptors syntax loop in Table 1B enables various types of descriptors to be provided for assets included in a package. In one example, transport package generator 600 may be configured to include one or more descriptors specifying video parameters in a MPT message. In one example, the descriptor may be referred to as a video stream properties descriptor. In one example, for each video asset, a video stream properties descriptor, video_stream_properties_descriptor( ) may be included within the syntax element asset_descriptors. In one example, a video stream properties descriptor, video_stream_properties_descriptor( ) may be included within the syntax element asset_descriptors only for certain video assets, for example only for video assets coded as H.265—High Efficiency Video Coding (HEVC) video assets. As described in detail below, a video stream properties descriptor may include information about one or more of: resolution, chroma format, bit depth, temporal scalability, bit-rate, picture-rate, color characteristics, profile, tier, and level. As further described in detail below, in one example, normative bitstream syntax and semantics for example descriptors may include presence flags for various video stream characteristics which can be individually toggled to provide various video characteristics information.

Further, signaling of various video characteristics information may be based on the presence or absence of temporal scalability. In one example, an element may indicate if temporal scalability is used in a stream. In one example, a conditionally signaled global flag may indicate if profile, tier, or level information is present for temporal sub-layers. As described in detail below, this condition may be based on an indication of the use of temporal scalability. In one example, a mapping and condition for the presence of a MMT dependency descriptor may be based on flags signaled in a video stream properties descriptor. In one example, reserved bits and a calculation of the length for reserved bits may be used for byte alignment.

As described detail below, video_stream_properties_descriptor( ) may include syntax elements defined in ITU-T H.265 and/or variation thereof. For example, a range of values for a syntax element defined in H.265 may be limited in video_stream_properties_descriptor( ). In one example, a picture rate code element may be used to signal commonly used picture rates (frame rates). Further, in one example, a picture rate code element may include a special value to allow signaling of any picture rate value. In one example, a syntax element nuh_layer_id values may be used for an MMT asset to associate it with an asset_id for a scalable and/or multi-view stream.

Example semantics for example fields of example video_stream_properties descriptors are respectively provided in Tables 2A-2D below. It should be noted that in each of Tables 2A-2D Format values of “H.265” include formats that are based on formats provided in ITU-T H.265 and described in further detail below and “TBD” includes formats to be determined. Further in Tables 2A-2D below, var represents a variable number of bits as further defined in a referenced Table.

TABLE 2A

| | No. of | |
|---|---|---|
| Syntax | Bits | Format |
| video_stream_properties_descriptor( ) { | | |
| descriptor_tag | 8 | TBD |
| deseriptor_length | 8 | uimsbf |
| temporal_scalability_present | 1 | bslbf |
| scalability_info_present | 1 | bslbf |
| multiview_info_present | 1 | bslbf |
| res_cf_bd_info_present | 1 | bsibf |
| pr_info_present | 1 | bslbf |
| br_info_present | 1 | bslbf |
| color_info_present | | |
| Reserved | 1 | ‘1’ |
| if(temporal_scalability_present) { | | |
| max_sub_layers_instream /* s */ | 6 | uimsbf |
| sub_layer_profile_tier_level_info_present | 1 | bslbf |
| Reserved | 1 | ‘1’ |
| } | | |
| if(scalability_info_present) { | | |
| scalability_info( ) | 8 or | Table 3A |
| | var | or 3B |
| } | | |
| if(multiview_info_present) { | | |
| multiview_info( ) | 40 or | Table 4A |
| | var | or 4B |
| } | | |
| if(res_cf_bd_info_present) { | | |
| res_cf_bd_info( ) | 48 | Table 5A |
| | | or 5B |
| } | | |
| if(pr_info_present) { | | |
| if(sub_layer_profile_tier_level_info_present) { | | |
| pr_info(max_sub_layers_instream-l) | var | Table 6A |
| | | or 6B |
| } else { | | |
| pr_info(0) | var | Table 6A |
| | | or 6B |
| } | | |
| } | | |
| if(br_info_present) { | | |
| if(sub_layer_profile_tier_level_info_present) { | | |
| br_info(max_sub_layers_instream-1) | var | Table 7 |
| } else { | | |
| br_info(0) | var | Table 7 |
| } | | |
| } | | |
| if(color_info_present) } | | |
| color_info( ) | 24 or | Table |
| | 32 or | 8A-8H |
| | var | |
| } | | |
| if(sub_layer_profile_tier_level_info_present) { | | |
| profile_tier_level(1, max_sub_layers_instream-1) | var | H.265 |
| } else { | | |
| profile_tier_level(1,0) | var | H.265 |
| } | | |
| } | | |

TABLE 2B

| | No. of | |
|---|---|---|
| Syntax | Bits | Format |
| video_stream_properties_descriptor( ) { | | |
| descriptor_tag | 8 | TBD |
| descriptor_length | 8 | uimsbf |
| codec_code | 4*8 | uimsbf |
| temporal_scalability_present | 1 | bslbf |
| scalability_info_present | 1 | bslbf |
| multiview_info_present | 1 | bslbf |
| res_cf_bd_info_present | 1 | bslbf |
| pr_info_present | 1 | bslbf |
| br_info_present | 1 | bslbf |
| color_info_present | | |
| reserved | 1 | ‘1’ |
| if(temporal_scalability_present) { | | |
| max_sub_layers_instream /* s */ | 6 | uimsbf |
| sub_layer_profile_tier_level_info_present | 1 | bslbf |
| reserved | 1 | ‘1’ |
| tid_max | 3 | uimsbf |
| tid_min | 3 | uimsbf |
| reserved2 | 2 | ‘11’ |
| } | | |
| if(scalability_info_present) { | | |
| scalability_info( ) | 8 or | Table |
| | var | 3A or |
| | | 3B |
| } | | |
| if(multiview_info_present) { | | |
| multiview_info( ) | 40 or | Table |
| | var | 4A or |
| | | 4B |
| if(res_cf bd_info_present) { | | |
| res_cf_bd_prop_info( ) | 48 | Table |
| | | 5A or |
| | | Table |
| | | 5B |
| } | | |
| if(pr_info_present) { | | |
| if(sub_layer_profile_tier_level_info_present) { | | |
| pr_info(max_sub_layers_instream-1) | var | Table |
| | | 6A or |
| | | 6B |
| } else { | | |
| pr_info(0) | var | Table |
| | | 6A or |
| | | 6B |
| } | | |
| } | | |
| if(br info_present) { | | |
| if(sub_layer_profile_tier_level_info_prcsent) } | | |
| br_info(max_sub_layers_instream-1) | var | Table 7 |
| } else { | | |
| br_info(0) | var | Table 7 |
| } | | |
| } | | |
| if(color_info_present) { | | |
| color_info( ) | 24 or | Table |
| | 32 or | 8A-8H |
| | var | |
| } | | |
| if(sub_layer_profile_tier_level_info_present) { | | |
| if(scalable_info_present \|\| multiview_info_present) { | | |
| profile_ tier_level(1,max_sub_layers_instream-1) | var | H.265 |
| } else { | | |
| profile_tier_level(max_sub_layers_instrcam-1) | var | H.265 |
| } | | |
| } else { | | |
| if(scalable_info_present \|\| multiview_info_present) { | | |
| profile_tier_level(1,0) | var | H.265 |
| } else { | | |
| profile_tier_level(0) | var | H.265 |
| } | | |
| } | | |
| } | | |

TABLE 2C

| | No. of | |
|---|---|---|
| Syntax | Bits | Format |
| video_stream_properties_deseriptor( ) { | | |
| descriptor_tag | 8 | TBD |
| descriptor_length | 8 | uimsbf |
| codec_indicator | 8 | uimsbf |
| temporal_scalability_present | 1 | bslbf |
| scalability_info_present | 1 | bslbf |
| multiview_info_present | 1 | bslbf |
| res_cf bd_info_present | 1 | bslbf |
| pr_info_present | 1 | bslbf |
| br_info_present | 1 | bslbf |
| color_info_present | | |
| reserved | 1 | ‘1’ |
| if(temporal_scalability_present) { | | |
| max_sub_layers_instream /* s */ | 6 | uimsbf |
| sub_layer_profile_tier_level_info_present | 1 | bslbf |
| reserved | 1 | ‘1’ |
| tid_max | 3 | uimsbf |
| tid_min | 3 | uimsbf |
| reserved2 | 2 | ‘11’ |
| } | | |
| if(scalability_info_present) { | | |
| scalability_info( ) | 8 or | Table 3A |
| | var | or 3B |
| } | | |
| if(multiview_info_present) { | | |
| multiview_info( ) | 40 or | Table 4A |
| | var | or 4B |
| } | | |
| if(res_cf_bd_info_present) { | | |
| res_cf_bd_prop_info( ) | 48 | Table 5A |
| | | or 5B |
| } | | |
| if(pr_info_present) { | | |
| if(sub_layer_profile_tier_level_info_present) { | | |
| pr_info(max_sub_layers_instream-1) | var | Table 6A |
| | | or 6B |
| } else { | | |
| pr_info(0) | var | Table 6A |
| | | or 6B |
| } | | |
| } | | |
| if(br_info_present) { | | |
| if(sub_layer_profile_tier_level_info_present) { | | |
| br_info(max_sub_layers_instream-1) | var | Table 7 |
| } else { | | |
| br_info(0) | var | Table 7 |
| } | | |
| } | | |
| if(color_info_present) { | | |
| color_info( ) | 24 or | Table |
| | 32 or | 8A-8H |
| | var | |
| } | | |
| if(sub_layer_profile_tier_level_info_present) { | | |
| if(scalable_info_present \|\| multiview_info_present) { | | |
| profile_tier_level(1,max_sub_layers_instream-1) | var | H.265 |
| } else { | | |
| profile_tier_level(max_sub_layers_instream-1) | var | H.265 |
| } | | |
| } else { | | |
| if(scalable_info_present \|\| multiview_info_present) { | | |
| profile_tier_level(1,0) | var | H.265 |
| } else { | | |
| profile_tier_level(0) | var | H.265 |
| } | | |
| } | | |
| } | | |

TABLE 2D

| | No. of | |
|---|---|---|
| Syntax | Bits | Format |
| video_stream_properties_descriptor( ) { | | |
| descriptor_tag | 8 | TBD |
| descriptor_length | 8 | uimsbf |
| codec_code | 4*8 | uimsbf |
| temporal_scalability_present | 1 | bslbf |
| scalability_info_present | 1 | bslbf |
| multiview_info_present | 1 | bslbf |
| res_cf_bd_info_present | 1 | bslbf |
| pr_info_present | 1 | bslbf |
| br_info_present | 1 | bslbf |
| color_info_present | | |
| reserved | 1 | ‘1’ |
| if(temporal_scalability_present) { | | |
| max_sub_layers_instream /* s */ | 6 | uimsbf |
| sub_layer_protile_tier_level_info_present | 1 | bslbf |
| reserved | 1 | ‘1’ |
| for (i=0;i<7;i++) { | | |
| tid_present[i] | 1 | bslbf |
| } | | |
| reserved | 1 | ‘1’ |
| } | | |
| if(scalability_info_present) { | | |
| scalability_info( ) | 8 or | Table |
| | var | 3A or |
| | | 3B |
| } | | |
| if(multiview_info_present) { | | |
| multiview_info( ) | 40 or | Table |
| | var | 4A or |
| | | 4B |
| } | | |
| if(res_cf_bd_info_present) { | | |
| res_cf_bd_info( ) | 48 | Table |
| | | 5A or |
| | | 5B |
| } | | |
| if(pr_info_present) { | | |
| if(sub_layer_profile_tier_level_info_present) { | | |
| pr_info(max_sub_layers_instream-1) | var | Table |
| | | 6A or |
| | | 6B |
| } else { | | |
| pr_info(0) | var | Table |
| | | 6A or |
| | | 6B |
| } | | |
| } | | |
| if(br_info_present) { | | |
| if(sub_layer_profile_tier_level_info_present) { | | |
| br_info(max_sub_layers_instream-1) | var | Table 7 |
| } else { | | |
| br_info(0) | var | Table 7 |
| } | | |
| } | | |
| if(color_info_present) { | | |
| color_info( ) | 24 or | Table |
| | 32 or | 8A-8H |
| | var | |
| } | | |
| if(sub_layer_profile_tier_level_info_present) { | | |
| profile_tier_level(1, max_sub_layers_instream-1) | var | H.265 |
| }else { | | |
| profile_tier_level(1,0) | var | H.265 |
| } | | |
| } | | |

Example syntax elements descriptor_tag, descriptor_length, temporal_scalability_present, scalability_info_present, multiview_info_present, res_cf_bd_info_present, pr_info_present, br_info_present, color_info_present, max_sub_layers_instream, and sub_layer_profile_tier_level_info_present, included in Tables 2A-Table 2D may be based on the following example definitions:
descriptor_tag—This 8-bit unsigned integer may have the value 0xTobedecided, identifying this descriptor. Where 0xTobedecided indicates a value to be decided. i.e. any particular fixed value may be used.
descriptor_length—This 8-bit unsigned integer may specify the length (in bytes) immediately following this field up to the end of this descriptor.
temporal_scalability_present—This 1-bit Boolean flag may indicate, when set to ‘1’, that the elements max_sub_layers_present and sub_layer_profile_tier_level_info_present are present and temporal scalability is provided in the asset or stream. When set to ‘0’, the flag may indicate that the elements max_sub_layers_present and sub_layer_profile_tier_level_info_present are not present and temporal scalability is not provided in the asset or stream.
scalability_info_present—This 1-bit Boolean flag may indicate, when set to ‘1’, that the elements in scalability_info( ) structure are present. When set to ‘0’, the flag may indicate that the elements in scalability_info( ) structure are not present.
multiview_info_present—This 1-bit Boolean flag may indicate, when set to ‘1’, that the elements in multiview_info( ) structure are present. When set to ‘0’, the flag may indicate that the elements in multiview_info( ) structure are not present.
res_cf_bd_info_present—This 1-bit Boolean flag may indicate, when set to ‘1’, that the elements in res_cf_bd_info( ) structure are present. When set to ‘0’, the flag may indicate that the elements in res_cf_bd_info( ) structure are not present.
pr_info_present—This 1-bit Boolean flag may indicate, when set to ‘1’, that the elements in pr_info( ) structure are present. When set to ‘0’, the flag may indicate that the elements in pr_info( ) structure are not present.
br_info_present—This 1-bit Boolean flag may indicate, when set to ‘1’, that the elements in br_info( ) structure are present. When set to ‘0’, the flag may indicate that the elements in br_info( ) structure are not present.
color_info_present—This 1-bit Boolean flag may indicate, when set to ‘1’, that the elements in color_info( ) structure are present. When set to ‘0’, the flag may indicate that the elements in color_info( ) structure are not present.
max_sub_layers_instream—This 6-bit unsigned integer may specify the maximum number of temporal sub-layers that may be present in each Coded Video Sequence (CVS) in the asset or video stream. In another example this 6-bit unsigned integer may specify the maximum number of temporal sub-layers that are present in each Coded Video Sequence (CVS) in the asset or video stream. The value of max_sub_layers_instream may be in the range of 1 to 7, inclusive.
sub_layer_profile_tier_level_info_present—This 1-bit Boolean flag may indicates, when set to ‘1’, that the profile, tier, level information may be or is present for temporal sub-layers in the asset or video stream. When set to ‘0’, the flag may indicate that the profile, tier, level information is not present for temporal sub-layers in the asset or video stream. When not present sub_layer_profile_tier_level_info_present may be inferred to be equal to 0.

As illustrated above, in addition to including example syntax elements descriptor_tag, descriptor_length, temporal_scalability_present, scalability_info_present, multiview_info_present, res_cf_bd_info_present, pr_info_present, br_info_present, color_info_present, max_sub_layers_instream, and sub_layer_profile_tier_level_info_present, Table 2B and Table 2D include syntax element codec_code. Syntax element codec_code may be based on the following example definition:
codec_code—This field specifies a 4-character code for codec. For this version of this specification the value of these four characters shall be one of ‘hev1’, ‘hev2’, ‘hcv1’, ‘hvc2’, ‘lhv1’ or ‘lhe1’ with semantic meaning for these codes as specified in ISO/IEC 14496-15.

That is, codec_code may identify a track type as described above with respect to Table 1A. In this manner, codec_code may indicate constraints associated with a layer and/or a stream of encoded video data.

As illustrated above, in addition to including example syntax elements descriptor_tag, descriptor_length, temporal_scalability_present, scalability_info_present, multiview_info_present, res_cf_bd_info_present, pr_info_present, br_info_present, color_info_present, max_sub_layers_instream, and sub_layer_profile_tier_level_info_present, Table 2C includes syntax element codec_indicator. Syntax element codec_indicator may be based on the following example definition:
codec_indicator—specifies a value which indicates 4-character code for codec. The defined values for codec_indicator are as follows 0=‘hev1’, 1=‘hev2’, 2=‘hvc1’, 3=‘hvc2’, 4=‘lhv1’ 5=‘lhe1’, 6-255=reserved; with semantic meaning for these codes as specified in ISO/IEC 14496-15.

That is, codec_indicator may identify a track type as described above with respect to Table 1A. In this manner, codec_indicator may indicate constraints associated with a layer and/or a stream of encoded video data.

As illustrated above, in addition to including example syntax elements descriptor_tag, descriptor_length, temporal_scalability_present, scalability_info_present, multiview_info_present, res_cf_bd_info_present, pr_info_present, br_info_present, color_info_present, max sub_layers_instream, and sub_layer_profile_tier_level_info_present, Table 2B and Table 2C include syntax elements tid_max and tid_min. Syntax elements tid_max and tid_min may be based on the following example definitions:
tid_max—This 3-bit field shall indicate the maximum value of TemporalId (as defined in ITU-T H.265) of all access units for this video asset. tid_max shall be in the range of 0 to 6, inclusive. tid_max shall be greater than or equal to tid_min.
In an example variant in a particular version of particular specification of standard the values allowed for tid_max may be restricted. For example, in one case, for a particular version of particular specification tid_max shall be in the range of 0 to 1, inclusive.
tid_min—This 3-bit field shall indicate the minimum value of TemporalId (as defined in Rec. ITU-T H.265) of all access units for this video asset. tid_min shall be in the range of 0 to 6, inclusive.
In an example variant in a particular version of particular specification of standard the values allowed for tid_min may be restricted. For example, in one case, for a particular version of particular specification tid_min shall be equal to 0.

As illustrated above, in addition to including example syntax elements descriptor_tag, descriptor_length, temporal_scalability_present, scalability_info_present, multiview_info_present, res_cf_bd_info_present, pr_info_present, br_info_present, color_info_present, max sub_layers_instream, and sub_layer_profile_tier_level_info_present, Table 2D includes syntax element tid_present[i]. Syntax elements tid_present[i] may be based on the following example definition:
tid_present[i]—This 1-bit Boolean flag shall indicate, when set to ‘1’, that the video asset includes TemporalId value (ITU-T H.265) equal to i in at least some access units. When set to ‘0’, indicates that the video asset does not include TemporalId value (ITU-T H.265) equal to i in any access unit.

As illustrated in Tables 2A-2D, based on the value of scalability_info_present, scalability_info( ) may be present. Example semantics for scalability_info( ) are provided in Table 3A.

TABLE 3A

| Syntax | No. of Bits | Format |
|---|---|---|
| scalability_info( ) { | | |
| asset_layer_id | 6 | uimsbf |
| reserved | 2 | ‘11’ |
| } | | |

Example syntax elements asset_layer_id in Table 3A may be based on the following example definitions:
asset_layer_id specifies the nuh_layer_id for this asset. The value of asset_layer_id may be in the range of 0 to 62, inclusive.

It should be noted that in one example, when scalable_info_present is equal to 1 or multiview_info_present is equal to 1 a Dependency Descriptor specified in section 9.5.3 of MMT specification may be required to be included in MPT for each asset. In this case the num_dependencies element in MMT Dependency Descriptor shall indicate the number of layers that the asset_layer_id for this asset is dependent on.

The asset_id( ) may use following to indicate information about assets that this asset is dependent on:
asset_id_scheme which identifies the scheme of asset ID as “URI”.
asset_id_value can indicate nuh_layer_id value.

Another example of semantics for scalability_info( ) are provided in Table 3B.

TABLE 3B

| Syntax | No. of | Format |
|---|---|---|
| | Bits | |
| scalability_info( ) { | | |
| asset_layer_id | 6 | uimsbf |
| num_layers_dep_on | 2 | uimsbf |
| for( i = 0; i < num_layers_dep_on | | |
| i++ ) { | | |
| dep_nuh_layer_id[ i ] | 6 | uimsbf |
| reserved2 | 2 | ‘11’ |
| } | | |
| } | | |

Example syntax elements asset_layer_id, num_layers_dep_on, and dep_nuh_layer_id in Table 3B may be based on the following example definitions:
asset_layer_id specifies the nuh_layer_id for this asset. The value of asset_layer_id shall be in the range of 0 to 62, inclusive.
num_layers_dep_on specifies the number of layers that the layer corresponding to this asset depends on. num_layers_dep_on shall be in the range of 0 to 2, inclusive. num_dep_on value of 3 is reserved.
dep_nuh_layer_id[i] specifies the nuh_layer_id for the asset that the current asset depends on. The value of dep_nuh_layer_id[i] shall be in the range of 0 to 62, inclusive.

In this manner scalability_info( ) may be used to signal a layer (e.g., a base layer or an enhancement layer) for an asset of encoded video data and any layer dependencies.

As illustrated in Tables 2A-2D, based on the value of multiview_info_present, multiview_info( ) may be present. Example semantics for multiview_info( ) are provided in Table 4A.

TABLE 4A

| Syntax | No. of Bits | Format |
|---|---|---|
| multiview_info( ) { | | |
| view_nuh_layer_id | 6 | uimsbf |
| view_pos | 6 | uimsbf |
| reserved4 | 4 | ‘1111’ |
| min_disp_with_offset | 11 | uimsbf |
| max_disp_range | 11 | uimsbf |
| reserved2 | 2 | ‘11’ |
| } | | |

Example syntax elements view_nuh_layer_id, view_pos, min_disp_with_offset, and max_disp_range in Table 4A may be based on the following example definitions:
view_nuh_layer_id specifies the nuh_layer_id for the view represented by this asset. The value of view_nuh_layer_id shall be in the range of 0 to 62, inclusive.
view_pos specifies the order of the view with nuh_layer_id equal to view_nuh_layer_id among all the views from left to right for the purpose of display, with the order for the left-most view being equal to 0 and the value of the order increasing by 1 for next view from left to right. The value of view_pos may be in the range of 0 to 62, inclusive.
min_disp_with_offset minus 1024 specifies the minimum disparity, in units of luma samples, between pictures of any spatially adjacent views among the applicable views in an access unit. The value of min_disp_with_offset may be in the range of 0 to 2047, inclusive. The access unit above may refer to HEVC access unit or to MMT access unit.
max_disp_range specifies that the maximum disparity, in units of luma samples, between pictures of any spatially adjacent views among the applicable views in an access unit. The value of max_disp_range may be in the range of 0 to 2047, inclusive. The access unit above may refer to HEVC access unit or to MMT access unit.
   Another example of semantics for multiview_info( ) are provided in Table 4B.

TABLE 4B

| Syntax | No. of Bits | Format |
|---|---|---|
| multiview_info( ) { | | |
| num_multi_views | 4 | uimsbf |
| for( i = 0; i < num_multi_views; | | |
| i++ ) { | | |
| view_nuh_layer_id[ i ] | 6 | uimsbf |
| view_pos[ i ] | 6 | uimsbf |
| } | | |
| if (num_multi_views%2) == 0 } | | |
| Reserved | 4 | ‘1111’ |
| } | | |
| min_disp_with_offset | 12 | uimsbf |
| max_disp_range | 12 | uimsbf |
| } | | |

Example syntax elements num_multi_views, view_nuh_layer_id, view_pos, min_disp_with_offset, and max_disp_range in Table 4B may be based on the following example definitions:
num_multi_views specifies the number of multi-view layers in the stream. num_multi_views may be in the range of 0 to 14, inclusive. num_multi_views value of 15 is reserved.
view_nuh_layer_id[i] specifies the nuh_layer_id for the view represented by this asset. The value of view_nuh_layer_id[i] may be in the range of 0 to 62, inclusive.
view_pos[i] specifies the order of the view with nuh_layer_id equal to view_nuh_layer_id[i] among all the views from left to right for the purpose of display, with the order for the left-most view being equal to 0 and the value of the order increasing by 1 for next view from left to right. The value of view_pos[i] may be in the range of 0 to 62, inclusive.
min_disp_with_offset minus 1024 specifies the minimum disparity, in units of luma samples, between pictures of any spatially adjacent views among the applicable views in an access unit. The value of min_disp_with_offset may be in the range of 0 to 2047, inclusive. The access unit above may refer to HEVC access unit or to MMT access unit.
max_disp_range specifics that the maximum disparity, in units of luma samples, between pictures of any spatially adjacent views among the applicable views in an access unit. The value of max_disp_range may be in the range of 0 to 2047, inclusive. The access unit above may refer to HEVC access unit or to MMT access unit.

In this manner multiview_info( ) may be used to provide information about multi-view parameters for an asset of encoded video data.

As illustrated in Tables 2A-2D, based on the value of res_cf_bd_info_present, res_cf_bd_info( ) may be present. Example semantics for res_cf_bd_info( ) are provided in Table 5A.

TABLE 5A

| Syntax | No. of Bits | Format |
|---|---|---|
| res_cf_bd_info( ) { | | |
| pic_width_in_luma_samples | 16 | uimsbf |
| pic_height_in_luma_samples | 16 | uimsbf |
| chroma_format_idc | 2 | uimsbf |
| if( chroma_format_idc = = 3) { | | |
| separate_colour_plane_flag | 1 | bslbf |
| reserved5 | 5 | ‘11111’ |
| } else { | | |
| reserved6 | 6 | ‘111111’ |
| } | | |
| bit_depth_luma_minus8 | 4 | uimsbf |
| bit_depth_chroma_minus8 | 4 | uimsbf |
| } | | |

Example syntax elements pic_width_in_luma_samples, pic_width_in_chroma_samples, chroma_format_idc, separate_colour_plane_flag, bit_depth_luma_minus8, and bit_depth_chroma_minus8 in Table 5A may respectively have the same semantics meaning as the elements with the same name in H.265 (October 2014) HEVC specification 7.4.3.2 (Sequence parameter set RBSP semantics).

Another example of semantics for res_cf_bd_info( ) are provided in Table 5B.

TABLE 5B

| Syntax | No. of Bits | Format |
|---|---|---|
| res_cf_bd_prop_info( ) { | | |
| pic_width_in_luma_samples | 16 | uimsbf |
| pic_height_in_luma_samples | 16 | uimsbf |
| chroma_format_idc | 2 | uimsbf |
| if( chroma_format_idc = = 3) { | | |
| separate_colour_plane_flag | 1 | bslbf |
| reserved3 | 3 | ‘111’ |
| } else { | | |
| reserved4 | 4 | ‘1111’ |
| } | | |
| video_still_present | 1 | bslbf |
| video_24hr_pic_present | 1 | bslbf |
| bit_depth_luma_minus8 | 4 | uimsbf |
| bit_depth_chroma_minus8 | 4 | uimsbf |
| } | | |

Example syntax elements pic_width_in_luma_samples, pic_width_in_chroma_samples, chroma_format_idc, separate_colour_plane_flag, bit_depth_luma_minus8, and bit_depth_chroma_minus8 in Table 5B may respectively have the same semantics meaning as the elements with the same name in H.265 (October 2014) HEVC specification 7.4.3.2 (Sequence parameter set RBSP semantics).

Syntax elements video_still_present and video_24hr_pic_present may be based on the following example definitions:
video_still_present—This 1-bit Boolean flag when set to ‘1’, shall indicate that the video asset may include HEVC still pictures as defined in ISO/IEC 13818-1. When set to ‘0’, the flag shall indicate that the video asset shall not include HEVC still pictures as defined in ISO/IEC 13818-1.
video_24hr_pic_present—This 1-bit Boolean flag when set to ‘1’, shall indicate that the video asset may include HEVC 24-hour pictures as defined in as defined in ISO/IEC 13818-1. When set to ‘0’, the flag shall indicate that the video asset shall not include any HEVC 24-hour picture as defined in ISO/IEC 13818-1.

In this manner, res_cf_bd_info( ) may be used to signal resolution, a chroma format, and bit depth for of encoded video data. In this manner, resolution, a chroma format, and bit depth may be referred to as picture quality.

As illustrated in Table 2A-2D, based on the value of pr_info_present, pr_info( ) may be present. Example semantics for pr_info( ) are provided in Table 6A.

TABLE 6A

| | No. of | |
|---|---|---|
| Syntax | Bits | Format |
| pr_info(maxSubLayersMinusl) { | | |
| for( i = 0; i <= maxSubLayersMinus1; | | |
| i++ ) { | | |
| picture_rate_code[ i ] | 8 | uimsbf |
| if( picture_rate_code[ i ] = = 255) { | | |
| average_picture_rate[ i ] | 16 | uimsbf |
| } | | |
| } | | |
| } | | |

Example syntax elements picture_rate_code and average_picture_rate[i] may be based on the following example definitions:
picture_rate_code[i]: picture_rate_code[i] provides information about the picture rate for the i'th temporal sub-layer of this video asset or stream. The picture_rate_code[i] code indicates following values for picture rate for the i'th temporal sub-layer: 0=unknown, 1=23.976 Hz, 2=24 Hz, 3=29.97 Hz, 4=30 Hz, 5=59.94 Hz, 6=60 Hz, 7=25 Hz, 8=50 Hz, 9=100 Hz, 10=120/1.001 Hz, 11=120 Hz, 12-254=reserved, 255=Other. When picture_rate_code[i] is equal to 255 the actual value of picture rate is indicated by the average_picture_rate[i] element.
average_picture_rate[i] indicates the average picture rate, in units of picture per 256 seconds, of the i-th temporal sub-layer. Semantics of avg_pic_rate[i] defined in H.265 (October 2014) HEVC specification section F.7.4.3.1.4 (VPS VUI (Video Usability Information) Semantics) apply. In one example, average_picture_rate[i] shall not have a value corresponding to either of picture rate values: 23.976 Hz, 24 Hz, 29.97 Hz, 30 Hz, 59.94 Hz, 60 Hz, 25 Hz, 50 Hz, 100 Hz, 120/1.001 Hz, 120 Hz. In this case, the picture_rate_code[i] shall be used to indicate the picture rate.

Another example of semantics for pr_info( ) are provided in Table 6B.

TABLE 6B

| | No. of | |
|---|---|---|
| Syntax | Bits | Format |
| pr_info(maxSubLayersMinusl) { | | |
| for( i =0; i <=maxSubLayersMinus1; | | |
| i++ ) { | | |
| picture_rate_code[ i ] | 8 | uimsbf |
| if( picture_rate_code[ i ] = = 255) { | | |
| constant_pic_rate_idc[ i ] | 2 | uimsbf |
| avg_pic_rate[+0i ] | 14 | uimsbf |
| } | | |
| } | | |
| } | | |

Example syntax elements picture_rate_code, constant_pic_rate_id, and average_picture_rate[i] may be based on the following example definitions:
picture_rate_code[i]: picture_rate_code[i] provides information about the picture rate for the i'th temporal sub-layer of this video asset or stream. The picture_rate_code[i] code indicates following values for picture rate for the i'th temporal sub-layer: 0=unknown, 1=23.976 Hz, 2=24 Hz, 3=29.97 Hz, 4=30 Hz, 5=59.94 Hz, 6=60 Hz, 7=25 Hz, 8=50 Hz, 9=100 Hz, 10=120/1.001 Hz, 11=120 Hz, 12-254=reserved, 255=Other. When picture rate code[i] is equal to 255 the actual value of picture rate is indicated by the average_picture_rate[i] element.
constant_pic_rate_idc[i] semantics of constant_pic_rate_idc[0][i] defined in H.265 (October 2014) HEVC specification section F.7.4.3.1.4 (VPS VIA Semantics) apply.
average_picture_rate[i] indicates the average picture rate, in units of picture per 256 seconds, of the i-th temporal sub-layer. Semantics of avg_pic_rate[0][i] defined in H.265 (October 2014) HEVC specification section F.7.4.3.1.4 (VPS VUI Semantics) apply. average_picture_rate[i] shall not have a value corresponding to either of picture rate values: 23.976 Hz, 24 Hz, 29.97 Hz, 30 Hz, 59.94 Hz, 60 Hz, 25 Hz, 50 Hz, 100 Hz, 120/1.001 Hz, 120 Hz. In this case the picture_rate_code[i] shall be used to indicate the picture rate.

It should be noted that H.265 (October 2014) HEVC specification includes avg_pic_rate[0][i] and also avg_pic_rate[j][i] for signaling the average picture rate and does not provide a mechanism for commonly used picture rates to be signaled easily. Besides the avg_pic_rate[j][i] of H.265 (October 2014) HEVC specification is in units of pictures per 256 seconds, where as a picture rate per second (Hz) is more desirable to be signalled. Thus, the use of picture_rate_code may provide for increased efficiency in signaling a picture rate of an asset of encoded video data.

As illustrated in Table 2A-2D, based on the value of br_info_present br_info( ) may be present. Example semantics for br_info( ) are provided in Table 7.

TABLE 7

| Syntax | No. of Bits | Format |
|---|---|---|
| br_info(maxSubLayersMinus1) { | | |
| for( i = 0; i <= | | |
| maxSubLayersMinus1; i++ ) { | | |
| average_bitrate[ i ] | 16 | uimsbf |
| maximum_bitrate[ i ] | 16 | uimsbf |
| } | | |
| } | | |

Example syntax elements average_bitrate, and maximum_bitrate[i] may be based on the following example definitions
average_bitrate[i] indicates the average bit rate of the i-th temporal sub-layer of this video asset or stream in bits per second. The value is calculated using BitRateBPS(x) function as defined in H.265 (October 2014) HEVC specification section F.7.4.3.1.4 (VPS VUI Semantics). Semantics of avg_bit_rate[0][i] defined in H.265 (October 2014) HEVC specification section F.7.4.3.1.4 (VPS VUI Semantics) apply.
maximum_bitrate[i] indicates maximum bit rate of the i-th temporal sub-layer in any one-second time window. The value is calculated using BitRateBPS(x) function as defined in H.265 (October 2014) HEVC specification section F.7.4.3.1.4 (VPS VUI Semantics). Semantics of max_bit_rate[0][i] defined in H.265 (October 2014) HEVC specification section F.7.4.3.1.4 (VPS VUI Semantics) apply.

In this manner, br_info may be used to signal a bit rate for an asset of encoded video data.

As illustrated in Table 2A-2D, based on the value of color_info_present, color_info( ) may be present. Example semantics for color_info( ) are provided in Table 8A.

TABLE 8A

| Syntax | No. of Bits | Format |
|---|---|---|
| color _info( ) { | | |
| colour_primaries | 8 | uimsbf |
| transfer_characteristies | 8 | uimsbf |
| matrix_coeffs | 8 | uimsbf |
| } | | |

In Table 8A, colour_primaries, transfer_characteristics, matrix_coeffs elements may respectively have the same semantics meaning as the elements with the same name in H.265 (October 2014) HEVC specification section E.3.1 (VUI Parameter Semantics). It should be noted that in some examples, each of colour_primaries, transfer_characteristics, matrix_coeffs may be based on more general definitions. For example, colour_primaries may indicate chromaticity coordinates of the source primaries, transfer_characteristics may indicates an opto-electronic transfer characteristic, and/or matrix_coeffs may describe matrix coefficients used in deriving luma and chroma signals from the green, blue, and red primaries. In this manner, color_info( ) may be used to signal color information for an asset of encoded video data.

Another example of semantics for color_info( ) are provided in Table 8B.

TABLE 8B

| Syntax | No. of Bits | Format |
|---|---|---|
| color_info( ) { | | |
| colour_primaries | 8 | uimsbf |
| transfer_characteristics | 8 | uimsbf |
| matrix_coeffs | 8 | uimsbf |
| if(colour_primaries==9) { | | |
| cg_compatibility | 1 | bslbf |
| reserved7 | 7 | ‘1111111’ |
| } | | |
| } | | |

In Table 8B, syntax elements may be based on the following example definitions:
colour_primaries, transfer_characteristics, and matrix_coeffs elements respectively may have the same semantics meaning as the elements with the same name in H.265 (October 2014) HEVC specification section E.3.1 (VUI Parameter Semantics).
cg_compatibility—This 1-bit Boolean flag may indicate, when set to ‘1’, that the video asset is coded to be compatible with Rec. ITU-R BT.709-5 color gamut. When set to ‘0’, the flag may indicate that the video asset is not coded to be compatible with Rec. ITU-R BT.709-5 color gamut.

In Table 8B the syntax element cg_compatibility signaled at transport layer allows a receiver or renderer to determine if a wide color gamut (e.g. Rec. ITU-R BT.2020) coded video asset is compatible with standard color gamut such as Rec. ITU-R BT.709-5 color gamut. Such indication may be useful in allowing a receiver to select for reception appropriate video assets based on the color gamut that the receiver supports. The compatibility with standard color gamut may mean that when a wide color gamut coded video is converted to standard color gamut no clipping occurs or that colors stay within standard color gamut.

Rec. ITU-R BT.709-5 is defined in “Rec. ITU-R BT.709-5, Parameter values for the HDTV standards for production and international programme exchange,” which is incorporated by reference in its entirety. Rec. ITU-R BT.2020 is defined in “Rec. ITU-R BT.2020, Parameter values for ultra-high definition television systems for production and international programme exchange,” which is incorporated by reference in its entirety.

In Table 8B the element cg_compatibility is conditionally signaled only when the color gamut indicated by colour_primaries element has a value, which corresponds to colour primaries being Rec ITU-R BT.2020. In other examples the element cg_compatibility may be signaled as shown in Table 8C.

TABLE 8C

| Syntax | No. of Bits | Format |
|---|---|---|
| color_info( ) { | | |
| colour_primaries | 8 | uimsbf |
| transfer_characteristics | 8 | uimsbf |
| matrix_coeffs | 8 | uimsbf |
| cg_compatibility | 1 | bslbf |
| reserved7 | 7 | ‘1111111’ |
| } | | |

In Table 8B and 8C after the syntax element cg_compatibility an element reserved7 which is 7-bit long sequence with each bit set to ‘1’ may be included. This may allow the overall color_info( ) to be byte aligned which may provide for easy parsing. In another example instead the reserved7 may be a sequence where each bit is ‘0’. In yet another example the reserved7 syntax element may be omitted and byte alignment may not be provided. Omitting reserved7 syntax element may be useful in the case where bit savings is important.

In other examples the semantics of the syntax element cg_compatibility may be defined as follows:
cg_compatibility—This 1-bit Boolean flag may indicate, when set to ‘1’, that the wide color gamut video asset is coded to be compatible with standard color gamut. When set to ‘0’, the flag may indicate that the wide color gamut video asset is not coded to be compatible with standard color gamut.

In another example definition of cg_compatibility, the term extended color gamut may be used instead of the term wide color gamut. In another example, the semantics for ‘0’ value for cg_compatbility element may indicate that it is unknown whether the video asset is coded to be compatible with standard color gamut.

In another example instead of using 1-bit for cg_compatibility, 2-bits may be used. Two examples of this syntax are shown in Table 8D and Table 8E, respectively. As illustrated, the difference between these two tables is that in Table 8D the syntax element cg_compatibility is signalled conditionally based on the value of syntax element colour_primaries, where as in Table 8E the syntax element cg_compatibility is always signalled.

TABLE 8D

| Syntax | No. of Bits | Format |
|---|---|---|
| color_info( ) { | | |
| colour_primaries | 8 | uimsbf |
| transfer_characteristics | 8 | uimsbf |
| matrix_coeffs | 8 | uimsbf |
| if(colour_primaries==9) { | | |
| cg_compatibility | 2 | uimsbf |
| reserved6 | 7 | ‘1111111’ |
| } | | |
| } | | |

TABLE 8E

| Syntax | No. of Bits | Format |
|---|---|---|
| color_info( ) { | | |
| colour_primaries | 8 | uimsbf |
| transfer_characteristics | 8 | uimsbf |
| matrix_coeffs | 8 | uimsbf |
| cg_compatibility | 2 | uimsbf |
| reserved7 | 6 | ‘1111111’ |
| } | | |

With respect to Table 8D and Table 8E the semantics of cg_compatibility may be based on the following example definition:
cg_compatibility—This 2-bit field may indicate, when set to ‘01’, that the video asset is coded to be compatible with Rec. ITU-R BT.709-5 color gamut. When set to ‘00’, the field may indicate that the video asset is not coded to be compatible with Rec. ITU-R BT.709-5 color gamut. When set to ‘10’, the field may indicate that it is unknown whether the video asset is coded to be compatible with Rec. ITU-R BT.709-5 color gamut. Value of ‘11’ for this field is kept reserved.

In another example the semantics of cg_compatibility may be based on the following example definition:
cg_compatibility—This 2-bit field may indicate, when set to ‘01’, that the video asset is coded to be compatible with standard color gamut. When set to ‘00’, the field may indicate that the video asset is not coded to be compatible with standard color gamut. When set to ‘10’, the field may indicate that it is unknown whether the video asset is coded to be compatible with standard color gamut. Value of ‘11’ for this field may be kept reserved.

When 2 bits are used to code the field cg_compatbility the next syntax element may change from ‘reserved7’ to ‘reserved6’ which is a 6-bit long sequence with each bit set to ‘1.’ This may allow the overall color_info( ) to be byte aligned which provides easy parsing. In another example instead the reserved6 there may be a sequence where each bit is ‘0’. In yet another example, the reserved6 syntax element may be omitted and byte alignment not provided. This may be the case if bit savings is important. With respect to Table 8B and Table 8D in one example, the cg_compatibility information may only be signalled for certain values of colour primaries. For example if colour_primaries is greater than or equal to 9 i.e. (colour_primaries>=9) instead of (colour_primaries==9).

Another example of syntax for color_info( ) is provided in Table 8F. In this case support is provided to allow inclusion of Electro-Optical Transfer Function (EOTF) information.

TABLE 8F

| Syntax | No. of Bits | Format |
|---|---|---|
| color info( ) { | | |
| colour_primaries | 8 | uimsbf |
| transfer_characteristics | 8 | uimsbf |
| matrix_coeffs | 8 | uimsbf |
| if(colour_primaries>=9) { | | |
| cg_compatibility | 1 | bslbf |
| reserved7 | 7 | ‘1111111’ |
| } | | |
| if(transfer_characteristics>=16) { | | |
| eotf_info_present | 1 | bslbf |
| if(eotf_info_present) { | | |
| eotf_info( ) | var | TBD |
| } | | |
| } | | |
| } | | |

In Table 8F, the semantics of eotf_info_present may be based on the following example definition
eotf_info_present—This 1-bit Boolean flag shall indicate, when set to ‘1’, that the elements in eotf_info( ) structure are present. When set to ‘0’, the flag shall indicate that the elements in eotf_info( ) structure are not present,
where eotf_info( ) provides Electro-Optical Transfer Function (EOTF) information data to be defined further.

In another example, the EOTF information may only be signalled for certain values of transfer characteristics. For example if transfer_characteristics is equal to 16 i.e. (transfer_characteristics==16) or if transfer_characteristics is equal to 16 or 17 i.e. ((transfer_characteristics==16)∥transfer_characteristics==17)).

In one example, in Table 8F semantics of cg_compatibility may be based on the following example definition.
cg_compatibility—This 1-bit Boolean flag shall indicate, when set to ‘1’, that the video asset is coded to be compatible with Rec. ITU R BT.709-5 color gamut. When set to ‘0’, the flag shall indicate that the video asset is not coded to be compatible with Rec. ITU R BT.709-5 color gamut.

Another example of semantics for color_info( ) are provided in Table 8G.

TABLE 8G

| Syntax | No. of Bits | Format |
|---|---|---|
| color info( ) { | | |
| colour_primaries | 8 | uimsbf |
| transfer_characteristies | 8 | uimsbf |
| matrix_coeffs | 8 | uimsbf |
| if(colour_primaries>=9) { | | |
| cg_compatibility | 1 | bslbf |
| reserved | 7 | ‘1111111’ |
| } | | |
| if(transfer_characteristics>=16) { | | |
| eotf_info_present | 1 | bslbf |
| if(eotf_info_present) { | | |
| eotf_info_len_minus1 | 15 | uimsbf |
| eotf_info( ) | (eotf_info_len_minus1+1)*8 | |
| } | | |
| else { | | |
| reserved | 7 | ‘1111111’ |
| } | | |
| } | | |
| } | | |

Another example of semantics for color_info( ) are provided in Table 8H.

TABLE 8H

| Syntax | No. of Bits | Format |
|---|---|---|
| color_info () { | | |
| colour_primaries | 8 | uimsbf |
| transfer_characteristics | 8 | uimsbf |
| matrix_coeffs | 8 | uimsbf |
| if(colour_primaries>=9) { | | |
| cg_compatibility | 1 | bslbf |
| reserved | 7 | ‘1111111’ |
| } | | |
| if(transfer_characteristies>=16) { | | |
| eotf_info_len | 16 | uimsbf |
| if (eotf_info_len > 0){ | | |
| eotf_info( ) | (eotf_info_len)*8 | |
| } | | |
| } | | |
| } | | |

In Tables 8G and Table 8H, syntax elements colour_primaries, transfer_characteristics, matrix_coeffs, and eotf_info_present may be based on the definitions provided above. With respect to Table 8G syntax element eotf_info_len_minus1 may be based on the following example definition:
eotf_info_len_minus1—This 15-bit unsigned integer plus 1 shall specify the length in bytes of the eotf_info( ) structure immediately following this field.

In another example in Table 8G, instead of syntax element eotf_info_len_minus, a syntax element eotf_info_len may be signalled. Thus, in this case, minus one coding is not used for signalling the length of eotf_info( ). In this case, the syntax element eotf_info_len may be based on the following example definition:
eotf_info_len—This 15-bit unsigned integer shall specify the length in bytes of the eotf_info( ) structure immediately following this field.

With respect to Table 8H syntax element eotf_info_len may be based on the following example definition:
eotf_info_len—This 16-bit unsigned integer when greater than zero shall specify the length in bytes of the eotf_info( ) structure immediately following this field. When eotf_info_len is equal to 0 no eotf_info( ) structure immediately follows this field.

Thus, each of Tables 8G and 8H provide mechanisms for signalling the length of eotf_info( ), which provides EOTF information data. It should be noted that signalling the length of EOTF information data may be useful for a receiver device that skips the parsing of eotf_info( ), e.g., a receiver device not supporting functions associated with etof_info( ). In this manner, a receiver device determining the length of etof_info( ) may determine the number of bytes in a bitstream to disregard.

It should be noted that ITU-T H.265 enables supplemental enhancement information (SEI) messages to be signaled. In ITU-T H.265, SEI messages assist in processes related to decoding, display or other purposes. However, SEI messages may not be required for constructing the luma or chroma samples by the decoding process. In ITU-T H.265, SEI messages may be signaled in a bitstream using non-VCL NAL units. Further, SEI messages may be conveyed by mechanisms other than by being present in the bitstream (i.e., signaled out-of-band). In one example, eotf_info( ) in color_info( ) may include data bytes for the SEI message NAL units as defined according to HEVC. Tables 9A-9C illustrate examples of semantics for eotf_info( ).

TABLE 9A

| Syntax | No. of Bits | Format |
|---|---|---|
| eotf_info( ) { | | |
| num_SEIs_minus1 | 8 | uimsbf |
| for ( i = 0; i <= num_SEIs_minus1; i++ ) { | | |
| SEI_NUT_length_minus1[ i ] | 16 | uimsbf |
| SEI_NUT_data[ i ] | 8*(SEI_NUT_length_minus1[i]+1) | |
| } | | |
| } | | |

TABLE 9B

| Syntax | No. of Bits | Format |
|---|---|---|
| eotf_info( ) { | | |
| num_SEIs_minus1 | 8 | uimsbf |
| for ( i = 0; i <= num_SEIs_minus1; i++ ) { | | |
| SEI_NUT_length_minus1[ i ] | 15 | uimsbf |
| reserved | 1 | ‘1’ |
| SEI_NUT_data[ i ] | 8*(SEI_NUT_length_minus1[i]+1) | |
| } | | |
| } | | |

TABLE 9C

| Syntax | No. of Bits | Format |
|---|---|---|
| eotf_info( ) { | | |
| num_SEIs_minus1 | 8 | uimsbf |
| for ( i = 0; i <= num_SEIs_minus1; i++ ) { | | |
| SEI_payload_type[i] | 8 | uimsbf |
| } | | |
| for ( i = 0; i <= num_SEIs_minus1; i++ ) { | | |
| SEI_NUT_length_minus1[ i ] | 15 | uimsbf |
| reserved | 1 | ‘1’ |
| SEI_NUT_data[ i ] | 8 *(SEI_NUT_length_minus1[i]+1) | |
| } | | |
| } | | |

With respect to Tables 9A-9C syntax elements num_SEIs_minus1, SEI_NUT_length_minus1[i], and SEI_NUT_data[i] may be based on the following example definitions:
num_SEIs_minus1 plus 1 indicates the number of supplemental enhancement information messages for which NAL unit data is signaled in this eotf_info( ).
SEI_NUT_length_minus1[i] plus 1 indicates the number of bytes of data in the SEI_NUT_data[i] field.
SEI_NUT_data[i] contains the data bytes for the supplemental enhancement information message NAL unit [As defined in HEVC]. nal_unit_type of NAL unit in SEI_NUT_data[i] shall be equal to 39 or 40.
For this version of this specification the payloadType value of SET message in SEI_NUT_data[i] shall be equal to 137 or 144.

It should be noted that a nal_unit_type of 39 is defined in HEVC as a PREFIX_SEI_NUT including Supplemental enhancement information and a nal_unit_type of 40 is defined in HEVC as a SUFFIX_SEI_NUT including an SEI Raw Byte Sequence Payload (RBSP). Further, it should be noted that a payloadType value equal to 137 corresponds to a mastering display colour volume SEI message in HEVC. ITU-T H.265 provides that a mastering display colour volume SEI message identifies the colour volume (i.e., the colour primaries, white point, and luminance range) of a display considered to be the mastering display for the associated video content—e.g., the colour volume of a display that was used for viewing while authoring the video content. Table 10 illustrates the semantics for a mastering display colour volume SEI message, mastering_display_colour_volume( ), as provided in ITU-T H.265. It should be note that in Table 10 and other tables herein, a descriptor u(n) refers to an unsigned integer using n-bits.

TABLE 10

| mastering_display_colour_volume( payloadSize ) { | Descriptor |
|---|---|
| for( c = 0; c< 3; c++ ) { | |
| display_primaries_x[ c ] | u(16) |
| display_primaries_y[ c ] | u(16) |
| } | |
| white_point_x | u(16) |
| white_point_y | u(16) |
| max_display_mastering_luminance | u(32) |
| min_display_mastering_luminance | u(32) |
| } | |

With respect to Table 10 syntax elements display_primaries_x[c], display_primaries_y[c], white_point_x, white_point_y, max_display_mastering_luminance, and min_display_mastering_luminance may be based on the following example definitions provided in ITU-T H.265:
display_primaries_x[c] and display_primaries_y[c] specify the normalized x and y chromaticity coordinates, respectively, of the colour primary component c of the mastering display in increments of 0.00002, according to the International Commission on Illumination (CIE) 1931 definition of x and y . . . The values of display_primaries_x[c] and display_primaries_y[c] shall be in the range of 0 to 50,000, inclusive.

white_point_x and white_point_y specify the normalized x and y chromaticity coordinates, respectively, of the white point of the mastering display in normalized increments of 0.00002, according to the International CIE 1931 definition of x and y . . . The values of white_point_x and white_point_y shall be in the range of 0 to 50,000.
max_display_mastering_luminance and min_display_mastering_luminance specify the nominal maximum and minimum display luminance, respectively, of the mastering display in units of 0.0001 candelas per square metre. min_display_mastering_luminance shall be less than max_display_mastering_luminance. At minimum luminance, the mastering display is considered to have the same nominal chromaticity as the white point.

Further, it should be noted that a payloadType value equal to 144 corresponds to a content light level information SEI message as provided in Joshi et al., ISO/IEC JTC 1/SC 29/WG 11, High Efficiency Video Coding (HEVC) Screen Content Coding: Draft 6, Document: JCTVC-W1005v4, which is incorporated by reference herein, provides that a content light level information SEI message identifies upper bounds for the nominal target brightness light level of pictures (i.e., an upper bound on a maximum light level and an upper bound on an average maximum light level). Table 11 illustrates the semantics for a content light level information SEI message, content_light_level_info( ) as provided in JCTVC-W1005v4.

TABLE 11

```
content_light_level_info( payloadSize ) {
  max_content_light _level
  max_pic_average_light_level
}
```

With respect to Table 11 syntax elements max_content_light_level and max_pic_average_light_level may be based on the following example definitions provided in JCTVC-W1005v4:
max_content_light_level, when not equal to 0, indicates an upper bound on the maximum light level among all individual samples in a 4:4:4 representation of red, green, and blue colour primary intensities (in the linear light domain) for the pictures of the coded layer-wise video sequence (CLVS), in units of candelas per square metre. When equal to 0, no such upper bound is indicated by max_content_light_level.

max_pic_average_light_level, when not equal to 0, indicates an upper bound on the maximum average light level among the samples in a 4:4:4 representation of red, green, and blue colour primary intensities (in the linear light domain) for any individual picture of the CLVS, in units of candelas per square metre. When equal to 0, no such upper bound is indicated by max_pic_average_light_level.

It should be noted that in Table 9B, the length of SEI_NUT_length_minus1 is adjusted considering the allowed length for eotf_info( ).

With respect to Table 9C syntax element SEI_payload_type[i] may be based on the following example definition
SEI_payload_type[i] indicates the payloadType of SEI message signalled in SEI_NUT_data[i] field.
For this version of this specification the SEI_payload_type[i] value shall be equal to 137 or 144.

It should be noted that in Table 9C, a separate “for loop” that indicates a pay-load Type of SEI messages included in an instance of eotf_info( ) is signaled before signaling of the actual SEI data. Such signaling allows a receiver device to parse the first “for loop” to determine if the SEI data (i.e., the data included in the second “for loop”) includes any SEI messages that enable useful functionality for the particular receiver device. Further, it should be noted that the data entries in the first “for loop” are fixed length and so are less complex to parse. This also allows jumping and directly accessing SEI data for only SEIs of use to the receiver or to even skip parsing of all SEI messages, if none of them are of use to the receiver based on their payloadType.

As illustrated in Tables 2A-2D, profile_tier_level( ) may be present based on the values of scalable_info_present and multiview_info_present. In one example, profile_tier_level( ) may include a profile, tier, level syntax structure as described in H.265 (October 2014) HEVC specification section 7.3.3.

It should be noted the video stream_properties_descriptor may be signaled in one or more of the following locations: a MMT Package (MP) Table, a ATSC service signaling in mmt_atsc3_message( ), and a ATSC service signaling in User Service Bundle Description (USBD)/User Service Description. Current proposals for the ATSC 3.0 suite of standards define a MMT signaling message (e.g., mmt_atsc3_message( ), where a MMT signaling message is defined to deliver information specific to ATSC 3.0 services. A MMT signaling message may be identified using a MMT message identifier value reserved for private use (e.g., a value of 0x8000 to 0xFFFF). Table 12 provides example syntax for a MMT signaling message mmt_atsc3_message( ).

As described above, in some instances, it may be beneficial for a receiving device to be able to access video parameters prior to decapsulating NAL units or ITU-T H.265 messages. Further, it may be beneficial for a receiving device to parse a mmt_atscs3_message( ) including a video stream_properties_descriptor( ) before parsing an MPU corresponding to the video asset associated with video_stream_properties_descriptor( ). In this manner, in one example, service distribution engine 500 may be configured to pass MMTP packets including a mmt_atscs3_message( ) including a video stream_properties_descriptor( ) to the UDP layer before passing MMTP packets including video assets to the UDP layer for a particular time period. For example, service distribution engine 500 may be configured to pass MMTP packets including a mmt_atscs3_message( ) including a video stream_properties_descriptor( ) to the UDP layer at the start of a defined interval and subsequently pass MMTP packets including video assets to the UDP layer. It should be noted that an MMTP packet may include a timestamp field that represents the Coordinated Universal Time (UTC) time when the first byte of an MMTP packet is passed to the UDP layer. Thus, for a particular time period, a timestamp of MMTP packets including a mmt_atscs3_message( ) including a video_stream_properties_descriptor( ) may be required to be less than a timestamp of MMTP packets including video assets corresponding to the video_stream_properties_descriptor( ). Further, service distribution engine 500 may be configured such that an order indicated by timestamp values is maintained up to the transmission of RF signals. That is, for example, each of transport/network packet generator 504, link layer packet generator 506, and/or frame builder and waveform generator 508 may be configured such that a MMTP packet including a mmt_atscs3_message( ) including a video_stream_properties_descriptor( ) is transmitted before MMTP packets including any corresponding video assets. In one example, it may be a requirement that a mmt_atsc3_message( ) carrying video_stream_properties_descriptor( ) shall be signaled for a video asset before delivering any MPU corresponding to the video asset.

Further, in some examples, in the case where a receiver device receives MMTP packets including video assets before receiving an MMTP packet including a mmt_atscs3_message( ) including a video_stream_properties_descriptor( ), the receiver device may delay parsing of the MMTP packets including corresponding video assets. For example, a receiver device may cause MMTP packets including video assets to be stored in one or more buffers. It should be noted that in some examples, one or more additional video stream_properties_descriptor( ) messages for a video asset may be delivered after delivery of a first video stream_properties_descriptor( ). For example, video stream_properties_descriptor( ) messages may be transmitted according to a specified interval (e.g, every 5 seconds). In some examples, each of the one or more additional video_stream_properties_descriptor( ) messages may be delivered after delivery of one or more MPUs following the first video_stream_properties_descriptor( ). In another example, for each video asset, a video_stream_properties_descriptor( ) may be required to be signaled which associates the video asset with a video_stream_properties_descriptor( ). Further, in one example, parsing of MMTP packets including video assets may be contingent on receiving a corresponding video_stream_properties_descriptor( ). That is, upon a channel change event, a receiver device may wait until the start of an interval as defined by a MMTP packet including a mmt_atscs3_message( ) including a video_stream_properties_descriptor( ) before accessing a corresponding video asset.

TABLE 12

| Syntax | No. of Bits | Format |
|---|---|---|
| mmt_atsc3_message( ) { | | |
| message_id | 16 | uimsbf |
| version | 8 | uimsbf |
| length | 32 | uimsbf |
| message payload { | | |
| service_id | 16 | uimsbf |
| atsc3_message_content_type | 8 | uimbsf |
| atsc3_message_content_version | 8 | uimbsf |
| atse3_message_content_compression | 8 | uimbsf |
| URI_length | 8 | uimbsf |
| for (i=0;i< URI_length;i++) { | | |
| URI_byte | 8 | uimsbf |
| } | | |
| atse3_message_content_length | 32 | uimsbf |
| for (i=0;i<atsc3_message_content_length;i++) { | | |
| atse3_message_content_byte | 8 | uimsbf |
| } | | |
| for (1=0;i<length-10-URI_length-atsc3_message_content_length) { | | |
| Reserved | 8 | uimsbf |
| } | | |
| } | | |
| } | | |

Current proposals for the ATSC 3.0 suite of standards provide the following definitions for syntax elements message_id, version, length, service_id, atsc3_message_content_type, atsc3_message_content_version, atsc3_message_content_compression, URI_length, URI_byte, atsc3_message_content_length, atsc3_message_content_byte, and reserved:
message_id—A 16-bit unsigned integer field that shall uniquely identify the mmt_atsc3_message( ). The value of this field shall be 0x8000.
version—An 8-bit unsigned integer field that shall be incremented by 1 any time there is a change in the information carried in this message. When the version field reaches its maximum value of 255, its value shall wraparound to 0.
length—A 32-bit unsigned integer field that shall provide the length of mmt_atsc3_message( ) in bytes, counting from the beginning of the next field to the last byte of the mmt_atsc3_message( ).
service_id—A 16-bit unsigned integer field that shall associate the message payload with the service identified in the serviceId attribute given in the Service Labeling Table (SLT).
atsc3_message_content_type—A 16-bit unsigned integer field that shall uniquely identify the type of message content in the mmt_atsc3_message( ) payload.
atsc3_message_content_version—An 8-bit unsigned integer field that shall be incremented by 1 any time there is a change in the atsc3_message_content identified by a service_id and atsc_message_content_type pair. When the atsc3_message_content_version field reaches its maximum value, its value shall wraparound to 0.
atsc3_message_content_compression—An 8-bit unsigned integer field that shall identify the type of compression applied to the data in atsc3_message_content_byte.
URI_length—An 8-bit unsigned integer field that shall provide the length of the Universal Resource Identifier (URI) uniquely identifying the message payload across services. If the URI is not present, the value of this field shall be set to 0.
URI_byte—An 8-bit unsigned integer field that shall contain a UTF-8 [where UTP is an acronym of unicode transformation format] character of the URI associated with the content carried by this message excluding the terminating null character, as per Internet Engineering Task Force (IETF) Request for Comments (RFC) 3986. This field when present shall be used to identify delivered message payloads. The URI can be used by system tables to reference tables made available by delivered message payloads.
atsc3_message_content_length—A 32-bit unsigned integer field that shall provide the length of the content carried by this message.
atsc3_message_content_byte—An 8-bit unsigned integer field that shall contain a byte of the content carried by this message.

In this manner, transport package generator 600 may be configured to signal various video stream characteristics using flags to indicate whether information regarding various video stream characteristics are present. This signaling may be particular useful for multimedia presentation including multiple video elements, including, for example, multimedia presentations which include multiple camera view presentations, three dimensional presentations through multiple views, temporal scalable video presentations, spatial and quality scalable video presentations.

It should be noted that MMTP specifies that signaling messages may be encoded in one of different formats, such as XML format. Thus, in one example XML, JSON, or other formats may be used for all or part of the video stream properties descriptor. Table 11 shows an exemplary video stream properties description XML format.

TABLE 13

| Element or Attribute Name | | Description |
|---|---|---|
| VidStreamPropos | Use | Root element of the Video Stream Properties Description |
| codecCode | 1 | This field specifies 4-character code for codec. For this |
| | | version of this specification the value of these four |
| | | characters shall be one of ‘hev1’, ‘hev2’, ‘hvc1’, ‘hvc2’, |
| | | ‘lhv1’ or ‘lhe1’ with semantic meaning for these codes as |
| | | specified in ISO/IEC 14496-15. |
| TemporalScalability | 1 | This 1-bit Boolean flag shall indicate, when set to ‘1’, |
| | | that the present and temporal scalability is provided in |
| | | the asset or stream. When set to ‘0’, the flag shall |
| | | indicate that the temporal scalability is not provided in |
| | | the asset or stream. |
| @max_sub_layers_in_stre | 1 | This unsigned integer shall specify the maximum number |
| am | | of temporal sub-layers that may be/are present in each |
| | | Coded Video Sequence (CVS) in the asset or video |
| | | stream. The value of @max_sub_layers_in_stream shall |
| | | be in the range of 1 to 7, inclusive. |
| @sub_layer_profile_tier_l | 0 . . . 1 | This 1-bit Boolean flag shall indicate, when set to ‘1’, |
| evel_info_present | | that the profile, tier, level information may be/is present |
| | | for temporal sub-layers in the asset or video stream. |
| | | When set to ‘0’, the flag shall indicate that the profile, |
| | | tier, level information is not present for temporal sub- |
| | | layers in the asset or video stream. When not present |
| | | @sub_layer_profile_tier_level_info_present is inferred to |
| | | be equal to 0. |
| @tid_max | 1 | This field shall indicate the maximum value of |
| | | TemporalId (as defined in ITU-T H.265) of all access |
| | | units for this video asset. tid_max shall be in the range of |
| | | 0 to 6, inclusive |
| @tid_min | 1 | This field shall indicate the minimum value of |
| | | TemporalId (as defined in ITU-T H.265) of all access |
| | | units for this video asset. tid_min shall be in the range of |
| | | 0 to 6, inclusive |
| @tid_present_mask | 1 | The i'th least significant bit of this unsigned byte field |
| | | shall indicate, when set to ‘1’, that the video asset |
| | | includes TemporalId value (as defined in ITU-T H.265) |
| | | equal to i in at least some access units. The i'th least |
| | | significant bit of this unsigned byte field when set to ‘0’, |
| | | indicates that the video asset does not include |
| | | TemporalId value (as defined in ITU-T H.265) equal to i |
| | | in any access unit. The value of most significant bit of |
| | | this field is ignored. |
| ScalabilityInfo | 0 . . . 1 | Provides scalability information about the asset or stream |
| @asset_layer_id | 1 | Specifies the nuh_layer_id for this asset or stream. The |
| | | value of asset_layer_id shall be in the range of 0 to 62, |
| | | inclusive. |
| MultiviewInfo | 0 . . . 1 | Provides multi-view information about the asset or |
| | | stream. |
| @view_nuh_layer_id | 1 | specifies the nuh_layer_id for the view represented by |
| | | this asset. @view_nuh_layer_id shall be in the range of 0 |
| | | to 62, inclusive. |
| @view_pos | 1 | specifies the order of the view with nuh_layer_id equal to |
| | | @view_nuh_layer_id among all the views from left to |
| | | right for the purpose of display, with the order for the |
| | | left-most view being equal to 0 and the value of the order |
| | | increasing by 1 for next view from left to right. The value |
| | | of @view_pos shall be in the range of 0 to 62, inclusive. |
| @min_disp_with_offset | 0 . . . 1 | @min_disp_with_offset minus 1024 specifies the minimum |
| | | disparity, in units of luma samples, between pictures of |
| | | any spatially adjacent views among the applicable views |
| | | in an access unit. The value of min_disp_with_offset |
| | | shall be in the range of 0 to 2047, inclusive. The access |
| | | unit above may refer to HEVC access unit or to MMT |
| | | access unit. |
| @max_disp_range | 0 . . . 1 | @max_disp_range specifies that the maximum disparity, |
| | | in units of luma samples, between pictures of any |
| | | spatially adjacent views among the applicable views in |
| | | an access unit. The value of max_disp_range shall be in |
| | | the range of 0 to 2047, inclusive. The access unit above |
| | | may refer to HEVC access unit or to MMT access unit. |
| ResCFBDInfo | 0 . . . 1 | Provides resolution, chroma format, bit-depth |
| | | information about the asset or stream. |
| @pic_width_in_luma_sa | 1 | has the same semantics meaning as the |
| mples | | pic_width_in_luma_samples syntax element in HEVC |
| | | specification section 7.4.3.2 (Sequence parameter set |
| | | RBSP semantics). |
| @pic_width_in_chroma_s | 1 | has the same semantics meaning as the |
| amples | | pic_height_in_luma_samples syntax element in HEVC |
| | | specification section 7.4.3.2 (Sequence parameter set |
| | | RBSP semantics). |
| @chroma_format_idc | 1 | has the same semantics meaning as the |
| | | chroma_format_idc syntax element in HEVC |
| | | specification section 7.4.3.2 (Sequence parameter set |
| | | RBSP semantics). |
| @separate_colour_plane_ | 0 . . . 1 | has the same semantics meaning as the |
| flag | | separate_colour_plane_flag syntax element in HEVC |
| | | specification section 7.4.3.2 (Sequence parameter set |
| | | RB SP semantics). |
| | | @separate_colour_plane_flag shall only be present when |
| | | @chroma_format_idc has a value equal to 3. |
| @bit_depth_luma_minus8 | 1 | has the same semantics meaning as the |
| | | bit_depth_luma_minus8 syntax element in HEVC |
| | | specification section 7.4.3.2 (Sequence parameter set |
| | | RBSP semantics). |
| @bit_depth_chroma_min | 1 | has the same semantics meaning as the |
| us8 | | bit_depth_chroma_minus8 syntax element in HEVC |
| | | specification section 7.4.3.2 (Sequence parameter set |
| | | RBSP semantics). |
| PRInfo | 0 or 1 or | Provides picture rate information about the asset or |
| | MaxSL | stream. There shall be |
| | | Exactly 0 or 1 of MaxSL occurrences of PRInfo element. |
| @TemporalSubLayer | 1 | Temporal sub-layer for which the picture rate |
| | | information is provided |
| <choice> | 1 | Only one of the picture_rate_code or |
| | | average_picture_rate elements shall be present inside a |
| | | PRInfo element |
| picture_rate_code | 0 . . . 1 | picture_rate_code provides information about the picture |
| | | rate for the temporal sub-layer @TemporalSubLayer. |
| | | The picture_rate_code indicates following values for |
| | | picture rate for the temporal sub-layer |
| | | @TemporalSubLayer: 0 = unknown, 1 = 23.976 Hz, 2 = |
| | | 24 Hz, 3 = 29.97 Hz, 4 = 30 Hz, 5 = 59.94 Hz, 6 = 60 Hz, |
| | | 7 = 25 Hz, 8 = 50 Hz, 9 = 100 Hz, 10 = 120/1.001 Hz, |
| | | 11 = 120 Hz, 12-255 = reserved. |
| average_picture_rate | 0 . . . 1 | average_picture_rate indicates the average picture rate, in |
| | | units of picture per 256 seconds, of the temporal sub- |
| | | layer @TemporalSubLayer. Semantics of |
| | | avg_pic_rate [0] [ i ] defined in HEVC section |
| | | F.7.4.3.1.4 (VPS VUI Semantics) apply. |
| | | average_picture_rate shall not have a value |
| | | corresponding to either of picture rate values: 23.976 Hz, |
| | | 24 Hz, 29.97 Hz, 30 Hz, 59.94 Hz, 60 Hz, 25 Hz, 50 Hz, |
| | | 100 Hz, 120/1.001 Hz, 120 Hz. In this case the |
| | | picture_rate_code element shall be used to indicate the |
| | | picture rate. |
| BRInfo | 0 or 1 or | Provides bit rate information about the asset or stream. |
| | MaxSL | There shall be |
| | | Exactly 0 or 1 of MaxSL occurrences of BRInfo element. |
| @TemporalSubLayer | 1 | Temporal sub-layer for which the bit rate information is |
| | | provided |
| @average_bit_rate | 1 | @average_bit_rate indicates the average bit rate of the |
| | | temporal sub-layer @TemporalSubLayer in bits per |
| | | second. The value is calculated using BitRateBPS( x ) |
| | | function as defined in HEVC section F.7.4.3.1.4 (VPS |
| | | VUI Semantics). Semantics of avg_bit_rate [ 0 ] [ i ] |
| | | defined in HEVC section F.7.4.3.1.4 (VPS VUI |
| | | Semantics) apply. |
| @maximum_bit_rate | 1 | @maximum_bit_rate indicates maximum bit rate of the |
| | | of the temporal sub-layer @TemporalSubLayer in any |
| | | one-second time window. The value is calculated using |
| | | BitRateBPS( x ) function as defined in HEVC Scalable |
| | | section F.7.4.3.1.4 (VPS VII Semantics). Semantics of |
| | | max_bit_rate[ 0 ][ i ] defined in HEVC section |
| | | F.7.4.3.1.4 (VPS VUI Semantics) apply. |
| ColorInfo | 0 . . . 1 | Provides color information about the asset or the stream. |
| @colour_primaries | 1 | Has the same semantics meaning as the syntax element |
| | | colour_primaries in HEVC specification section E.3.1 |
| | | (VUI Parameter Semantics). |
| @transfer_characteristics | 1 | Has the same semantics meaning as the syntax element |
| | | transfer_characteristics in HEVC specification section |
| | | E.3.1 (VUI Parameter Semantics). |
| @matrix_coeffs | 1 | Has the same semantics meaning as the syntax element |
| | | matrix_coeffs in section E.3.1 (VUI Parameter |
| | | Semantics). |
| @cg_compatibility | 1 | This 1-bit Boolean flag shall indicate, when set to ‘1’, |
| | | that the wide color gamut video asset is coded to be |
| | | compatible with standard color gamut. When set to ‘0’, |
| | | the flag shall indicate that the wide color gamut video |
| | | asset is not coded to be compatible with standard color |
| | | gamut. |
| eotf_info | 0 . . . 1 | Provides Electro-Optical Transfer Function (EOTF) |
| | | information data. |

It should be noted that more, fewer, or different element may be included in Table 13. For example, the variations described above with respect to Table 2A-9C above may be applicable to Table 13.

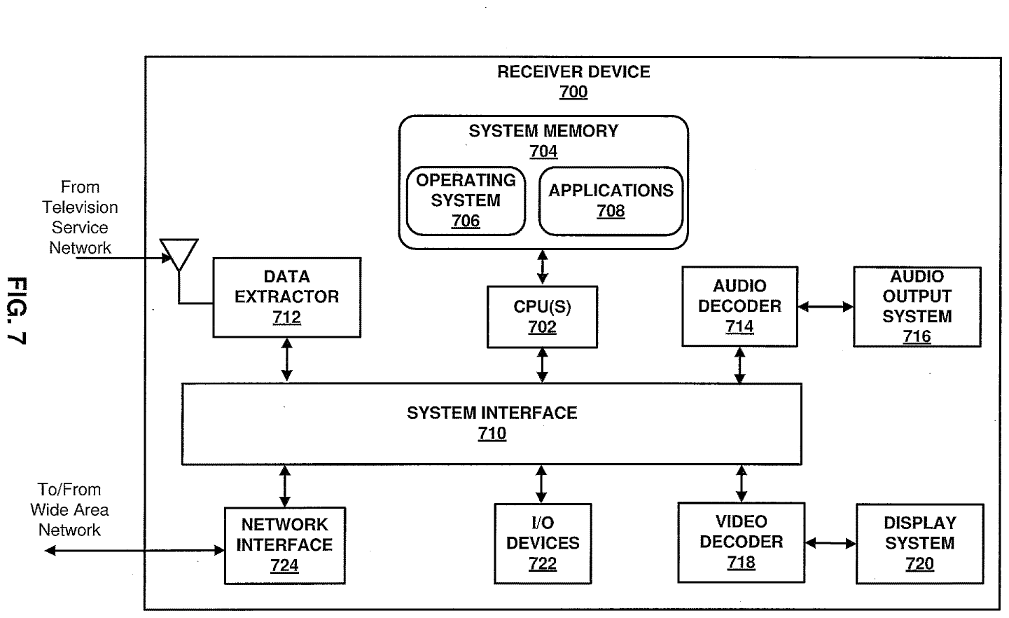

FIG. 7 is a block diagram illustrating an example of a receiver device that may implement one or more techniques of this disclosure. Receiver device 700 is an example of a computing device that may be configured to receive data from a communications network and allow a user to access multimedia content. In the example illustrated in FIG. 7, receiver device 700 is configured to receive data via a television network, such as, for example, television service network 104 described above. Further, in the example illustrated in FIG. 7, receiver device 700 is configured to send and receive data via a wide area network. It should be noted that in other examples, receiver device 700 may be configured to simply receive data through a television service network 104. The techniques described herein may be utilized by devices configured to communicate using any and all combinations of communications networks.

As illustrated in FIG. 7, receiver device 700 includes central processing unit(s) 702, system memory 704, system interface 710, data extractor 712, audio decoder 714, audio output system 716, video decoder 718, display system 720, I/O device(s) 722, and network interface 724. As illustrated in FIG. 7, system memory 704 includes operating system 706 and applications 708. Each of central processing unit(s) 702, system memory 704, system interface 710, data extractor 712, audio decoder 714, audio output system 716, video decoder 718, display system 720, I/O device(s) 722, and network interface 724 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 700 is illustrated as having distinct functional blocks, such an illustration is for descriptive purposes and does not limit receiver device 700 to a particular hardware architecture. Functions of receiver device 700 may be realized using any combination of hardware, firmware and/or software implementations.

CPU(s) 702 may be configured to implement functionality and/or process instructions for execution in receiver device 700. CPU(s) 702 may include single and/or multi-core central processing units. CPU(s) 702 may be capable of retrieving and processing instructions, code, and/or data structures for implementing one or more of the techniques described herein. Instructions may be stored on a computer readable medium, such as system memory 704.

System memory 704 may be described as a non-transitory or tangible computer-readable storage medium. In some examples, system memory 704 may provide temporary and/or long-term storage. In some examples, system memory 704 or portions thereof may be described as non-volatile memory and in other examples portions of system memory 704 may be described as volatile memory. System memory 704 may be configured to store information that may be used by receiver device 700 during operation. System memory 704 may be used to store program instructions for execution by CPU(s) 702 and may be used by programs running on receiver device 700 to temporarily store information during program execution. Further, in the example where receiver device 700 is included as part of a digital video recorder, system memory 704 may be configured to store numerous video files.

Applications 708 may include applications implemented within or executed by receiver device 700 and may be implemented or contained within, operable by, executed by, and/or be operatively/communicatively coupled to components of receiver device 700. Applications 708 may include instructions that may cause CPU(s) 702 of receiver device 700 to perform particular functions. Applications 708 may include algorithms which are expressed in computer programming statements, such as, for-loops, while-loops, if-statements, do-loops, etc. Applications 708 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 700 includes a smart television, applications may be developed by a television manufacturer or a broadcaster. As illustrated in FIG. 7, applications 708 may execute in conjunction with operating system 706. That is, operating system 706 may be configured to facilitate the interaction of applications 708 with CPUs(s) 702, and other hardware components of receiver device 700. Operating system 706 may be an operating system designed to be installed on set-top boxes, digital video recorders, televisions, and the like. It should be noted that techniques described herein may be utilized by devices configured to operate using any and all combinations of software architectures.

System interface 710 may be configured to enable communications between components of receiver device 700. In one example, system interface 710 comprises structures that enable data to be transferred from one peer device to another peer device or to a storage medium. For example, system interface 710 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 700 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 7, data extractor 712 may be configured to extract video, audio, and data from a signal. A signal may be defined according to, for example, aspects DVB standards, ATSC standards, ISDB standards, DTMB standards, DMB standards, and DOCSIS standards.

Data extractor 712 may be configured to extract video, audio, and data, from a signal generated by service distribution engine 500 described above. That is, data extractor 712 may operate in a reciprocal manner to service distribution engine 500. Further, data extractor 712 may be configured to parse link layer packets based on any combination of one or more of the structures described above.

Data packets may be processed by CPU(s) 702, audio decoder 714, and video decoder 718. Audio decoder 714 may be configured to receive and process audio packets. For example, audio decoder 714 may include a combination of hardware and software configured to implement aspects of an audio codec. That is, audio decoder 714 may be configured to receive audio packets and provide audio data to audio output system 716 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 716 may be configured to render audio data. For example, audio output system 716 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 718 may be configured to receive and process video packets. For example, video decoder 718 may include a combination of hardware and software used to implement aspects of a video codec. In one example, video decoder 718 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 AVC), and High-Efficiency Video Coding (HEVC). Display system 720 may be configured to retrieve and process video data for display. For example, display system 720 may receive pixel data from video decoder 718 and output data for visual presentation. Further, display system 720 may be configured to output graphics in conjunction with video data, e.g., graphical user interfaces. Display system 720 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 722 may be configured to receive input and provide output during operation of receiver device 700. That is, I/O device(s) 722 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 722 may be operatively coupled to receiver device 700 using a standardized communication protocol, such as for example, Universal Serial Bus protocol (USB), Bluetooth, ZigBee or a proprietary communications protocol, such as, for example, a proprietary infrared communications protocol.

Network interface 724 may be configured to enable receiver device 700 to send and receive data via a local area network and/or a wide area network. Network interface 724 may include a network interface card, such as an Ethernet card, an optical transceiver, a radio frequency transceiver, or any other type of device configured to send and receive information. Network interface 724 may be configured to perform physical signaling, addressing, and channel access control according to the physical and Media Access Control (MAC) layers utilized in a network.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1-20. (canceled)

21: A method for signaling video parameters associated with a video asset included in a multimedia presentation, the method comprising:
signaling a descriptor associated with the video asset;
signaling a first syntax element indicating a length in bytes of an electro-optical transfer function information data structure; and
signaling the electro-optical transfer function information data structure corresponding to the first syntax element, wherein
the electro-optical transfer function information data structure includes (i) one or more supplemental enhancement information messages and (ii) a second syntax element indicating the number of supplemental enhancement information messages.

22: The method of claim 21, wherein the first syntax element is 15 bits.

23: The method of claim 21, wherein:
the descriptor includes color information, the color information conditionally including a first flag indicating whether the electro-optical transfer function information data structure is present; and
in the case where the first flag indicates that the electro-optical transfer function information data structure is present, the first syntax element and the electro-optical transfer function information data structure are signaled.

24: The method of claim 23, wherein:
the color information corresponds to the video asset based on a second flag indicating that the color information is present in the descriptor; and
the first flag is signaled based on whether a code value included in the color information is greater than a predetermined value.

25: The method of claim 21, wherein for each of the indicated number of supplemental enhancement information messages, the electro-optical transfer function information data structure includes a third syntax element indicating the number of bytes of the supplemental enhancement information messages.

26: The method of claim 25, wherein the second syntax element is 8 bits.

27: The method of claim 26, wherein the third syntax element is 16 bits.

28: The method of claim 21, wherein:
the descriptor is identified as a video descriptor using a descriptor tag value; and
the video asset is transported using a unidirectional physical layer.

29: A device for rendering a video asset included in a multimedia presentation, the device comprising one or more processors configured to:
receive a descriptor associated with a video asset;
parse a first syntax element indicating a length in bytes of an electro-optical transfer function information data structure; and
parse the electro-optical transfer function information data structure corresponding to the first syntax element, wherein
the electro-optical transfer function information data structure includes (i) one or more supplemental enhancement information messages and (ii) a second syntax element indicating the number of supplemental enhancement information messages.

30: The device of claim 29, wherein the first syntax element is 15 bits.

31: The device of claim 29, wherein the one or more processors are further configured to:
parse color information corresponding to the video asset based on a first flag indicating that the color information is present in the descriptor;
parse a second flag indicating whether the electro-optical transfer function information data structure is present based on whether a code value included in the color information is greater than a predetermined value; and
based on a value of the second flag, parse the first syntax element and the electro-optical transfer function information data structure.

32: The device of claim 29, wherein for each of the indicated number of supplemental enhancement information messages, the electro-optical transfer function information data structure includes a third syntax element indicating the number of bytes of the supplemental enhancement information messages.

33: The device of claim 32, wherein:
the second syntax element is 8 bits; and
the third syntax element is 16 bits.

34: The device of claim 29, wherein the one or more processors are further configured to disregard the number of bytes indicated by the first syntax element.

35: A method for determining one or more parameters of a video asset included in a multimedia presentation, the method comprising:
receiving a descriptor associated with a video asset; and
parsing electro-optical transfer function information, wherein parsing the electro-optical transfer function information includes parsing a first syntax element indicating a length in bytes of an electro-optical transfer function information data structure, wherein
the electro-optical transfer function information data structure includes (i) one or more supplemental enhancement information messages and (ii) a second syntax element indicating the number of supplemental enhancement information messages.

36: The method of claim 35, wherein the first syntax element is 15 bits.

37: The method of claim 35, further comprising:
parsing color information corresponding to the video asset based on a first flag indicating that the color information is present in the descriptor;
parsing a second flag indicating whether the electro-optical transfer function information data structure is present based on whether a code value included in the color information is greater than a predetermined value; and
based on a value of the second flag, parsing the first syntax element and the electro-optical transfer function information data structure.

38: The method of claim 35, wherein for each of the indicated number of supplemental enhancement information messages, the electro-optical transfer function information data structure includes a third syntax element indicating the number of bytes of the supplemental enhancement information messages.

39: The method of claim 38, wherein:
the second syntax element is 8 bits; and
the third syntax element is 16 bits.

40: The method of claim 35, further comprising disregarding the number of bytes indicated by the first syntax element.
